(19) United States
(12) Patent Application Publication
(10) Pub. No.: US 2013/0113768 A1
(43) Pub. Date: May 9, 2013

(54) DISPLAY DEVICE AND DRIVE METHOD FOR SAME

(71) Applicants: Kaoru Yamamoto, Osaka (JP); Yasuhiro Sugita, Osaka (JP); Kohei Tanaka, Osaka (JP)

(72) Inventors: Kaoru Yamamoto, Osaka (JP); Yasuhiro Sugita, Osaka (JP); Kohei Tanaka, Osaka (JP)

(73) Assignee: SHARP KABUSHIKI KAISHA, Osaka (JP)

(21) Appl. No.: 13/810,823

(22) PCT Filed: Jul. 26, 2011
(86) PCT No.: PCT/JP2011/066903

§ 371 Date: Jan. 17, 2013

(30) Foreign Application Priority Data
Jul. 27, 2010 (JP) 2010-168688

(51) Int. Cl. G09G 5/00

(52) U.S. Cl. CPC G09G 5/003
USPC 345/207

(57) ABSTRACT

Disclosed is a display device having an optical sensor with increased sensitivity. The display device is provided with: a display panel that includes a plurality of display pixel circuits (8) and a plurality of sensor pixel circuits (9a) in a display region (4); and a driver circuit (7) that supplies a driving signal to the sensor pixel circuits (9a). The sensor pixel circuits (9a) are each provided with: a light receiving element (PD1); a storage node (INT) that retains electrical charges corresponding to the light amount that entered the light receiving element (PD1); and a read-out switching element (M1) connected to the storage node (INT). The display device is further provided with a first switching element (T1) that is connected between the light receiving element (PD1) and the storage node (INT) and that operates in a saturation region, and a second switching element (T2) that resets the storage node (INT).

### TECHNICAL FIELD

The present invention relates to a display device, and more particularly, to a display device having a plurality of optical sensors disposed in a pixel region.

### BACKGROUND ART

In a conventional display device, a technique of providing a plurality of optical sensors to a display panel so as to realize an input function such as a touch panel, a stylus input, or a scanner is known. As an example of an optical sensor, a circuit configuration shown in FIG. 33 that includes a photodiode PD1, a capacitor C_{INT}, and a transistor M1 is known (see WO 2007/145346 and WO 2007/145347).

In this conventional optical sensor, the gate of the transistor M1 is connected to a storage node INT. The storage node INT is connected to one electrode of the capacitor C_{INT} and to one electrode (cathode) of the photodiode PD1. The other electrode (anode) of the photodiode PD1 is connected to a reset line RST. The other electrode of the capacitor C_{INT} is connected to a read-out line RWS.

The conventional optical sensor operates as follows. First, in a reset period, the reset line RST is applied with a voltage that makes the photodiode PD1 forward-biased. This way, in the reset period, the storage node INT is reset to a prescribed potential. When the reset period is over, the reset line is applied with a voltage that makes the photodiode PD1 reverse-biased. In an accumulation period following the reset period, electrical charges are accumulated in the storage node INT. In a read-out period following the accumulation period, the read-out line RWS is applied with a read-out voltage, which allows the transistor M1 to read out the electrical charges that were accumulated in the storage node INT during the accumulation period.

In order to improve the sensitivity of the conventional optical sensor described above, it is necessary to reduce the capacitance of C_{INT}, or to increase the size or number of the photodiode PD1. However, when the size or number of the photodiode PD1 is increased, the load capacitance thereof is also increased, and therefore, it was difficult to effectively improve the sensitivity. To solve this problem, the present invention is aiming at providing a display device equipped with an optical sensor with higher sensitivity.

### SUMMARY OF THE INVENTION

In order to achieve the above-mentioned object, a display device disclosed herein includes: a display panel that has a plurality of display pixel circuits and a plurality of sensor pixel circuits in a display region; and a driver circuit that supplies a driving signal to the sensor pixel circuits, wherein each of the sensor pixel circuits includes: a light-receiving element; a storage node that retains electrical charges corresponding to an amount of light that entered the light-receiving element; and a read-out switching element that is connected to the storage node, wherein the display device further includes: a first switching element that is connected between the light-receiving element and the storage node, the first switching element being operated in a saturation region; and a second switching element that resets the storage node.

According to the present invention, a display device that includes an optical sensor with improved sensitivity can be provided.

### BRIEF DESCRIPTION OF THE DRAWINGS

FIG. 1 is a block diagram showing a configuration of a display device according to an embodiment of the present invention.

FIG. 2 is a diagram showing an arrangement of sensor pixel circuits in a display panel included in the display device shown in FIG. 1.

FIG. 3 is a circuit diagram showing a specific configuration of a sensor pixel circuit of Embodiment 1.

FIG. 4 is a waveform diagram of driving signals that drive the sensor pixel circuit of Embodiment 1.

FIG. 5 is a waveform diagram showing changes in various signals in the sensor pixel circuit around the times ta to tc shown in FIG. 4.

FIG. 6A is a schematic diagram showing an operation of the sensor pixel circuit when supplied with the driving signals shown in FIGS. 4 and 5.

FIG. 6B is a schematic diagram showing an operation of the sensor pixel circuit when supplied with the driving signals shown in FIGS. 4 and 5.

FIG. 6C is a schematic diagram showing an operation of the sensor pixel circuit when supplied with the driving signals shown in FIGS. 4 and 5.

FIG. 7 is a circuit diagram showing a configuration of a modification example of the sensor pixel circuit of Embodiment 1.

FIG. 8 is a circuit diagram showing a configuration of a modification example of the sensor pixel circuit of Embodiment 1.

FIG. 9 is a circuit diagram showing a configuration of a modification example of the sensor pixel circuit of Embodiment 1.

FIG. 10 is a circuit diagram showing a configuration of a modification example of the sensor pixel circuit of Embodiment 1.

FIG. 11 is a circuit diagram showing a configuration of a modification example of the sensor pixel circuit of Embodiment 1.

FIG. 12 is a circuit diagram showing a configuration of a modification example of the sensor pixel circuit of Embodiment 1.

FIG. 13 is a circuit diagram showing a configuration of a modification example of the sensor pixel circuit of Embodiment 1.

FIG. 14 is a circuit diagram showing a configuration of a modification example of the sensor pixel circuit of Embodiment 1.

FIG. 15 is a circuit diagram showing a configuration of a modification example of the sensor pixel circuit of Embodiment 1.

FIG. 16 is a circuit diagram showing a configuration of a modification example of the sensor pixel circuit of Embodiment 1.

FIG. 17 is a circuit diagram showing a configuration of a modification example of the sensor pixel circuit of Embodiment 1.

FIG. 18 is a circuit diagram showing a configuration of a modification example of the sensor pixel circuit of Embodiment 1.

FIG. 19 is a circuit diagram showing a configuration of a modification example of the sensor pixel circuit of Embodiment 1.

FIG. 20 is a waveform diagram showing driving signals applied to a sensor pixel circuit and changes in potentials Vsig and Vint in Embodiment 2.

FIG. 21 is a diagram showing an arrangement of sensor pixel circuits in a pixel region of a display device of Embodiment 3.

FIG. 22 is a chart showing timing at which the backlight is turned on and off, and timing at which the reset and read-out operations for the sensor pixel circuit are performed.

FIG. 23A is a circuit diagram showing an example of a specific configuration of a first sensor pixel circuit of Embodiment 3.

FIG. 23B is a circuit diagram showing an example of a specific configuration of a second sensor pixel circuit of Embodiment 3.

FIG. 24 is a signal waveform diagram of a display panel of Embodiment 3.

FIG. 25 is a circuit diagram of the sensor pixel circuit of Embodiment 3.

FIG. 26 is a circuit diagram showing a configuration of a modification example of the sensor pixel circuit of Embodiment 3.

FIG. 27 is a circuit diagram showing a configuration of a modification example of the sensor pixel circuit of Embodiment 3.

FIG. 28 is a circuit diagram showing a configuration of a modification example of the sensor pixel circuit of Embodiment 3.

FIG. 29 is a circuit diagram showing a configuration of a modification example of the sensor pixel circuit of Embodiment 3.

FIG. 30 is a circuit diagram showing a configuration of a modification example of the sensor pixel circuit of Embodiment 3.

FIG. 31 is a circuit diagram showing a configuration of a modification example of the sensor pixel circuit of Embodiment 3.

FIG. 32 is a signal waveform diagram of a display panel of Embodiment 4.

FIG. 33 is a circuit diagram showing a configuration of a conventional optical sensor.

### DETAILED DESCRIPTION OF EMBODIMENTS

A display device according to an embodiment of the present invention is provided with:

a display panel that includes a plurality of display pixel circuits and a plurality of sensor pixel circuits in a display region; and

a driver circuit that supplies a driving signal to the sensor pixel circuits,

wherein each of the sensor pixel circuits includes:

a light-receiving element;

a first storage node that accumulates electrical charges corresponding to an amount of light that entered the light-receiving element;

a second storage node that is provided to retain electrical charges at the first storage node;

a read-out switching element that is connected to the second storage node;

a first switching element that is connected between the first storage node and the second storage node, the first switching element being operated in a saturation region when electrical charges accumulated in the first storage node are transferred to the second storage node; and

a second switching element that is connected to the second storage node, the second switching element being provided for resetting the first and second storage nodes (first configuration).

In the first configuration,

each of the sensor pixel circuits may further include a capacitor that is connected between the second storage node and a read-out signal line, and

the second switching element may have a gate connected to a reset line, a source connected to a fixed voltage source, and a drain connected to the second storage node (second configuration).

Alternatively, in the first configuration,

each of the sensor pixel circuits may further include a capacitor that is connected between the second storage node and a read-out signal line, and

the second switching element may have a gate connected to a reset line, a source connected to the read-out signal line, and a drain connected to the second storage node (third configuration).

In the first to third configurations,

it is preferable that the driver circuit perform a sensing operation during a unit period that includes:

a reset period during which the first switching element is turned on, the second switching element is turned on, and the first and second storage nodes are reset;

an accumulation period during which the first switching element is turned off, the second switching element is turned off, and electrical charges corresponding to an amount of light received by the light-receiving element are accumulated in the first storage node;

a transfer period during which the first switching element is turned on, the second switching element is turned off, and electrical charges that were accumulated in the first storage node during the accumulation period are transferred to the second storage node; and

a read-out period during which the first switching element is turned off, the second switching element is turned off, and the read-out switching element is turned on, thereby performing a read-out operation (fourth configuration).

Alternatively, in the first to third configurations,

it is preferable the driver circuit perform a sensing operation during a unit period that includes:

a reset period during which the first switching element is turned on, the second switching element is turned on, and the first and second storage nodes are reset;

an accumulation and transfer period during which the first switching element is turned on, the second switching element is turned off, and electrical charges corresponding to an amount of light received by the light-receiving element are accumulated in the first storage node, while transferring electrical charges that were accumulated in the first storage node during the accumulation period to the second storage node; and

a read-out period during which the first switching element is turned off, the second switching element is turned off, and the read-out switching element is turned on, thereby performing a read-out operation (fifth configuration).

In the first to fifth configurations,

it is preferable that the display device further include a light source that is turned on only for a prescribed period of time during one frame period, and

the display device be configured such that the sensor pixel circuits include a first sensor pixel circuit and a second sensor pixel circuit, the first sensor pixel circuit detecting light during a detection period in which the light source is on, the second sensor pixel circuit detecting light during a detection period in which the light source is off, and

the driver circuit performs a read-out operation from the first and second sensor pixel circuits in a line-sequential manner during a period other than the detection period in which the light source is on and the detection period in which the light source is off (sixth configuration).

In the sixth configuration,

it is more preferable that the display device be configured such that the light source is turned on for a prescribed period of time only once during one frame period, and

one frame period includes one detection period in which the light source is on and one detection period in which the light source is off (seventh configuration).

In the sixth or seventh configuration,

it is preferable that the first sensor pixel circuit and the second sensor pixel circuit share a single optical sensor (eighth configuration).

In the first to eighth configurations,

it is preferable that the first capacitor is a P-type transistor (ninth configuration).

In the first to eighth configurations,

it is preferable that each of the sensor pixel circuits further include a reference light-receiving element that is connected to the light-receiving element in series and that is shielded from light, and

the first storage node be connected between the light-receiving element and the reference light-receiving element (tenth configuration).

In the first to eighth configurations,

the light-receiving element may be an N-type transistor (eleventh configuration).

In the first to eighth configurations,

it is preferable the display device further include a select switching element that is connected to the read-out switching element in series, the select switching element being provided to establish and break electrical continuity between the second storage node and an output line of the sensor pixel circuit.

A driving method of a display device according to an embodiment of the present invention is a driving method of a display device that is provided with: a display panel that includes a plurality of display pixel circuits and a plurality of sensor pixel circuits in a display region; and a driver circuit that supplies a driving signal to the sensor pixel circuits, wherein each of the sensor pixel circuits includes: a light-receiving element; a first storage node that accumulates electrical charges corresponding to an amount of light that entered the light-receiving element; a second storage node that is provided to retain electrical charges at the first storage node; a read-out switching element that is connected to the second storage node; a first switching element that is connected between the first storage node and the second storage node, the first switching element being operated in a saturation region when electrical charges accumulated in the first storage node are transferred to the second storage node; and a second switching element that is connected to the second storage node, the second switching element being provided for resetting the first and second storage nodes,

the driving method including a sensing operation that is performed by the driver circuit during a unit period, the sensing operation including:

a reset process in which the first switching element is turned on, the second switching element is turned on, and the first and second storage nodes are reset;

an accumulation process in which the first switching element is turned off, the second switching element is turned off, and electrical charges corresponding to an amount of light received by the light-receiving element are accumulated in the first storage node;

a transfer process in which the first switching element is turned on, the second switching element is turned off, and electrical charges that were accumulated in the first storage node during the accumulation process are transferred to the second storage node; and

a read-out process in which the first switching element is turned off, the second switching element is turned off, and the read-out switching element is turned on, thereby performing a read-out operation.

A driving method of a display device according to another embodiment of the present invention is a driving method of a display device that is provided with: a display panel that includes a plurality of display pixel circuits and a plurality of sensor pixel circuits in a display region; and a driver circuit that supplies a driving signal to the sensor pixel circuits, wherein each of the sensor pixel circuits includes: a light-receiving element; a first storage node that accumulates electrical charges corresponding to an amount of light that entered the light-receiving element; a second storage node that is provided to retain electrical charges at the first storage node; a read-out switching element that is connected to the second storage node; a first switching element that is connected between the first storage node and the second storage node, the first switching element being operated in a saturation region when electrical charges accumulated in the first storage node are transferred to the second storage node; and a second switching element that is connected to the second storage node, the second switching element being provided for resetting the first and second storage nodes,

the driving method including a sensing operation that is performed by the driver circuit during a unit period, the sensing operation including:

a reset process in which the first switching element is turned on, the second switching element is turned on, and the first and second storage nodes are reset;

an accumulation and transfer process in which the first switching element is turned on, the second switching element is turned off, and electrical charges corresponding to an amount of light received by the light-receiving element are accumulated in the first storage node, while transferring electrical charges that were accumulated during the accumulation period in the first storage node to the second storage node; and

a read-out process in which the first switching element is turned off, the second switching element is turned off, and the read-out switching element is turned on, thereby performing a read-out operation.

### Embodiments

Below, specific embodiments of the present invention will be explained with reference to figures. The following embodiments describe configuration examples in a case in which the display device according to the present invention is implemented as a liquid crystal display device. However, the display device of the present invention is not limited to a liquid crystal display device, and can be applied to other display devices that use an active matrix substrate. The display device according to the present invention is equipped with optical sensors, and can therefore be used as a display device equipped with a touch panel that performs an input operation by detecting an object near a screen, a dual-communication display device that has both a display function and an image-capturing function, or the like.

For ease of explanation, each of the figures that are referred to in the following descriptions only shows, in a simple manner, main components that are necessary to explain the present invention, out of constituting components of embodiments of the present invention. Therefore, it is possible that the display device of the present invention includes appropriate constituting components that are not shown in any of the figures that are referred to in the present specification. Dimensions of the components in each figure do not truthfully represent the dimensions of the actual constituting components, dimensional ratios of the respective components, or the like.

### Embodiment 1

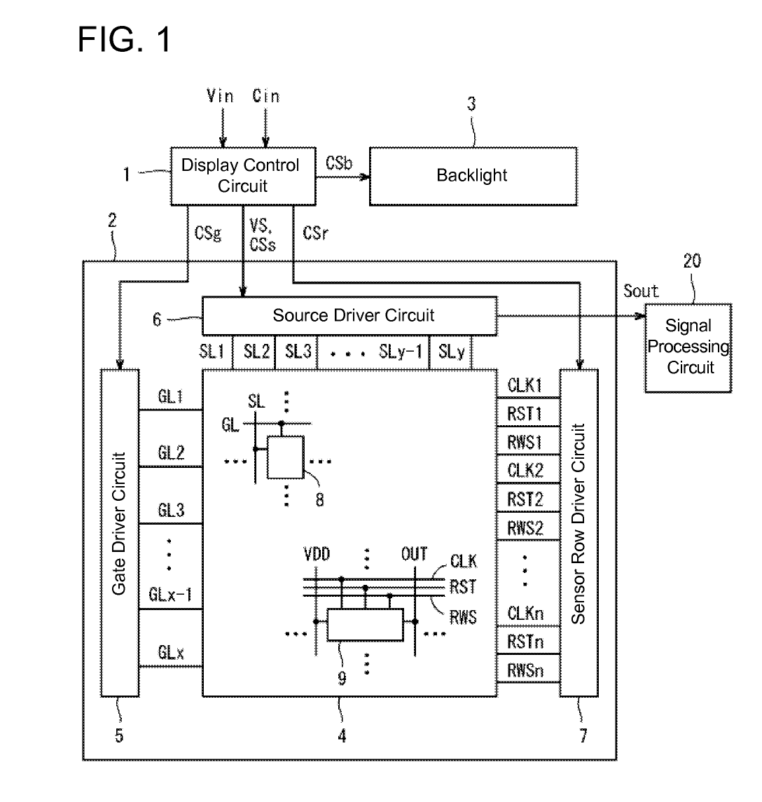

FIG. 1 is a block diagram showing a configuration of the display device according to Embodiment 1 of the present invention. The display device shown in FIG. 1 includes a display control circuit 1, a display panel 2, and a backlight 3. The display panel 2 includes a pixel region 4, a gate driver circuit 5, a source driver circuit 6, and a sensor row driver circuit 7. The pixel region 4 includes a plurality of display pixel circuits 8 and a plurality of sensor pixel circuits 9. This display device has a function of displaying an image on the display panel 2, and a function of detecting light that entered the display panel 2. In the following descriptions, “x” is an integer of 2 or greater, “y” is a multiple of 3, “m” and “n” are even numbers, and the frame rate of the display device is 60 frames per second.

The display device shown in FIG. 1 is applied with an image signal Vin and a timing control signal Cin from the outside. Based on these signals, the display control circuit 1 outputs an image signal VS and control signals CSg, CSs, and CSr to the display panel 2, and outputs a control signal CSb to the backlight 3. The image signal VS may be the same as the image signal Vin, or may be a signal that was obtained by processing the image signal Vin.

The backlight 3 is a light source for sensing, which is provided in addition to a light source for display, and radiates light to the display panel 2. More specifically, the backlight 3 is disposed on the rear surface side of the display panel 2, and radiates light to the rear surface of the display panel 2. The backlight 3 is turned on when the control signal CSb is at a high level, and is turned off when the control signal CSb is at a low level. As the backlight 3, an infrared light source or the like can be used, for example.

In the pixel region 4 of the display panel 2, (x×y) number of display pixel circuits 8 and (n×m/2) number of sensor pixel circuits 9 are respectively arranged two-dimensionally. More specifically, in the pixel region 4, “x” number of gate lines GL1 to GLx and “y” number of source lines SL1 to SLy are provided. The gate lines GL1 to GLx are arranged in parallel with each other, and the source lines SL1 to SLy are arranged in parallel with each other so as to intersect with the gate lines GL1 to GLx. The (x x y) number of display pixel circuits 8 are provided near respective intersections of the gate lines GL1 to GLx and the source lines SL1 to SLy. Each display pixel circuit 8 is connected to one gate line GL and one source line SL. Three types of display pixel circuits 8 are respectively provided for red color display, green color display, and blue color display. These three types of display pixel circuits 8 are arranged side by side in a direction in which the gate lines GL1 to GLx are extended, constituting one color pixel.

In the pixel region 4, “n” number of clock lines CLK1 to CLKn, “n” number of reset lines RST1 to RSTn, and “n” number of read-out lines RWS1 to RWSn are disposed in parallel with the gate lines GL1 to GLx. Also, in the pixel region 4, other signal lines or power lines (not shown) may be disposed in parallel with the gate lines GL1 to GLx. In a read-out operation from the sensor pixel circuits 9, “m” number of lines that are selected from the source lines SL1 to SLy are used as power supply lines VDD1 to VDDm, and other “m” source lines are used as output lines OUT1 to OUTm.

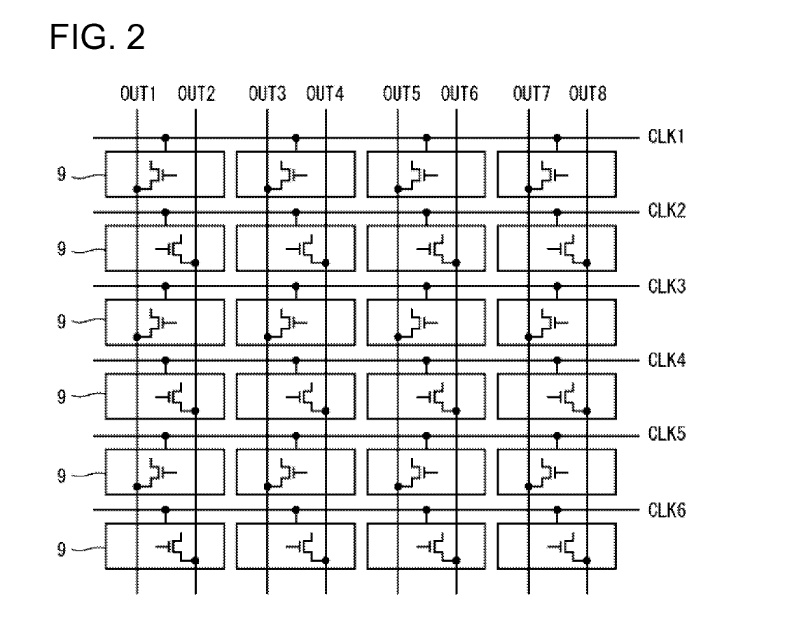

FIG. 2 is a diagram showing an arrangement of the sensor pixel circuits 9 in the pixel region 4. In FIG. 2, each of the (n×m/2) number of sensor pixel circuits 9 is connected to one clock line CLK and one output line OUT. In FIG. 2, of the (n×m/2) number of sensor pixel circuits 9, the sensor pixel circuits 9 connected to odd-numbered clock lines CLK1 to CLKn-1 are connected to odd-numbered output lines OUT1 to OUTm-1. The sensor pixel circuits 9 connected to even-numbered clock lines CLK2 to CLKn are connected to even-numbered output lines OUT2 to OUTm.

The gate driver circuit 5 drives the gate lines GL1 to GLx. More specifically, based on the control signal CSg, the gate driver circuit 5 selects one gate line out of the gate lines GL1 to GLx sequentially, and applies a high-level potential to the selected gate line, and a low-level potential to the other gate lines. This way, “y” number of display pixel circuits 8 that are connected to the selected gate line are collectively selected.

The source driver circuit 6 drives the source lines SL1 to SLy. More specifically, based on the control signal CSs, the source driver circuit 6 applies potentials corresponding to the image signal VS to the source lines SL1 to SLy. At this time, the source driver circuit 6 may drive the source lines in a line-sequential manner or a dot-sequential manner. The potentials applied to the source lines SL1 to SLy are written into “y” number of display pixel circuits 8 that are selected by the gate driver circuit 5. As described above, by writing potentials corresponding to the image signal VS into all of the display pixel circuits 8 using the gate driver circuit 5 and the source driver circuit 6, a desired image can be displayed on the display panel 2.

The sensor row driver circuit 7 drives the clock lines CLK1 to CLKn, the reset lines RST1 to RSTn, the read-out lines RWS1 to RWSn, and the like. More specifically, based on the control signal CSr, the sensor row driver circuit 7 applies a high-level potential and a low-level potential to the clock lines CLK1 to CLKn at prescribed timing (as described later in detail). Also, based on the control signal CSr, the sensor row driver circuit 7 selects one reset line out of the reset lines RST1 to RSTn, and applies a high-level potential for resetting to the selected reset line, and a low-level potential to the other reset lines. This way, “m” number of sensor pixel circuits 9 connected to the reset line that is applied with the high-level potential are collectively reset.

Also, based on the control signal CSr, the sensor row driver circuit 7 selects one read-out line out of the read-out lines RWS1 to RWSn sequentially, and applies a high-level potential for reading-out to the selected read-out line, and applies a low-level potential to the other read-out lines. This way, “m” number of sensor pixel circuits 9 that are connected to the selected read-out line are collectively turned into a read-out ready state. At this time, the source driver circuit 6 applies a high-level potential to the power supply lines VDD1 to VDDm. This causes the “m” number of sensor pixel circuits 9, which are in the read-out ready state, to output signals corresponding to the amounts of light detected by the respective sensor pixel circuits 9 (referred to as sensor signals below) to the output lines OUT1 to OUTm. The output lines OUT double as the source lines SL, and the sensor signals outputted to the output lines OUT are sent to the source driver circuit 6.

The source driver circuit 6 amplifies the sensor signals outputted from the output lines OUT, and outputs the amplified signals to the outside of the display panel 2 as sensor output Sout. The sensor output Sout, as necessary, undergoes an appropriate process conducted by the signal processing circuit 20 provided outside the display panel 2. As described above, by reading out the sensor signals from all of the sensor pixel circuits 9 using the source driver circuit 6 and the sensor row driver circuit 7, light that entered the display panel 2 can be detected.

The number of the sensor pixel circuits 9 disposed in the pixel region 4 may be appropriately selected. For example, it is possible to provide (n×m) number of sensor pixel circuits 9 in the pixel region 4, or to provide the same number of sensor pixel circuits 9 as that of the color pixels (that is, (x×y/3)) in the pixel region 4. Alternatively, it is possible to provide a smaller number of the sensor pixel circuits 9 in the pixel region 4 than that of the color pixels (with a ratio of one to several or one to several dozens, for example).

As described above, the display device according to an embodiment of the present invention is a display device having a plurality of photodiodes (optical sensors) disposed in the pixel region 4, and includes: the display panel 2 having a plurality of display pixel circuits 8 and a plurality of sensor pixel circuits 9; and a sensor row driver circuit 7 (driver circuit) that outputs driving signals such as a clock signal CLK to the sensor pixel circuits 9.

Below, a configuration and a driving method of the sensor pixel circuit 9 will be explained. In the following description, signals on the respective signal lines are distinguished from each other by using the same reference characters as the corresponding signal lines (for example, a signal on the clock line CLK1 is referred to as a clock signal CLK1).

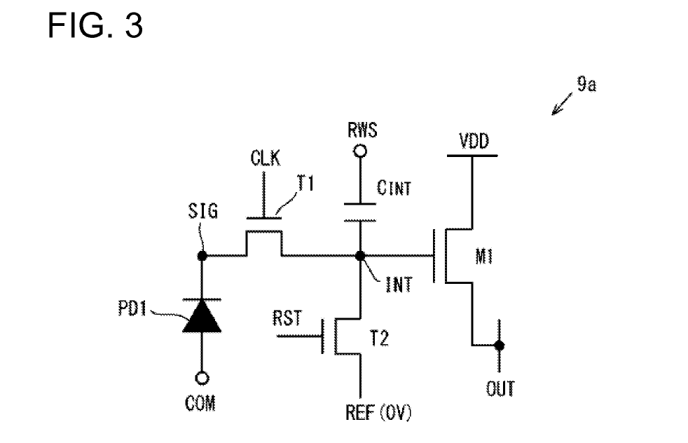

FIG. 3 is a circuit diagram showing a configuration of a sensor pixel circuit 9a, which is a specific example of the sensor pixel circuit 9. As shown in FIG. 3, the sensor pixel circuit 9a is connected to a clock line CLK, a reset line RST, a read-out line RWS, a power supply line VDD, and an output line OUT. The sensor pixel circuit 9a includes a photodiode PD1, transistors T1, T2, and M1, and a capacitor C_{INT}. The transistors T1, T2, and M1 are N-type TFTs (thin film transistors), for example. The anode of the photodiode PD1 is connected to a fixed voltage source COM. The cathode of the photodiode PD1 is connected to the source of the transistor T1. The gate of the transistor T1 is connected the clock line CLK. The drain of the transistor T1 is connected to the gate of the transistor M1. The drain of the transistor M1 is connected to the power supply line VDD, and the source is connected to the output line OUT. The transistor M1 functions as a read-out transistor. The capacitor C_{INT} is disposed between the gate of the transistor M1 and the read-out line RWS. In the transistor T2, the gate is connected to the reset line RST, the drain is connected to the capacitor C_{INT}, and the source is connected to a power supply line REF that supplies a reference voltage Vref. The reference voltage Vref is set to 0V, for example, but not limited thereto.

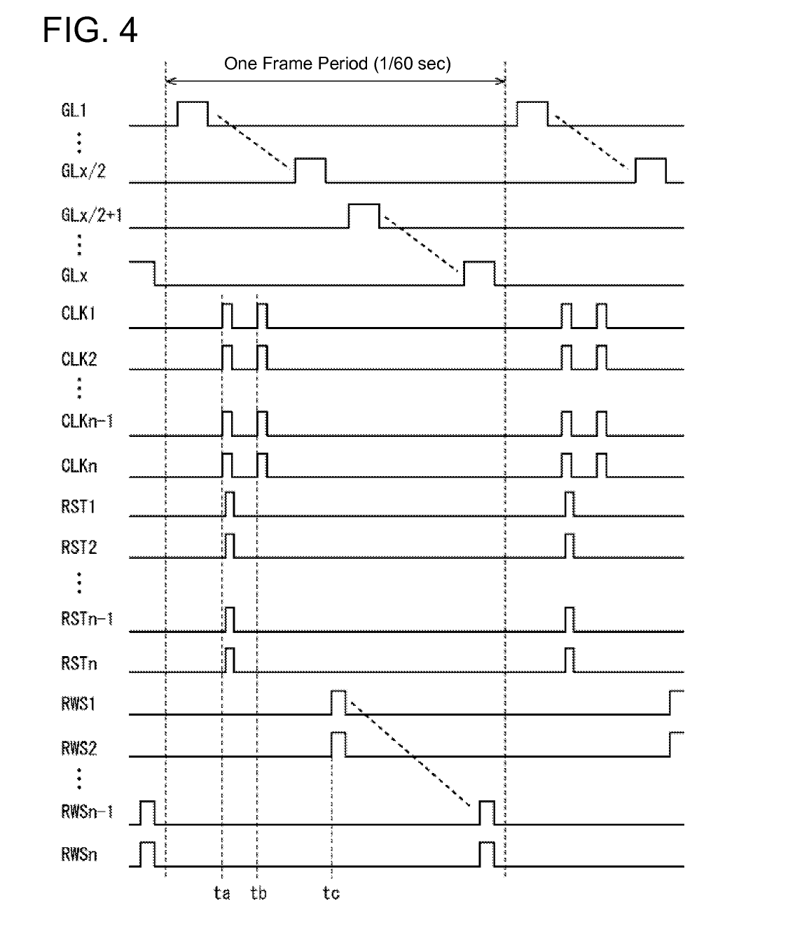

FIG. 4 is a waveform diagram of driving signals that drive the sensor pixel circuit 9. As shown in FIG. 4, the gate line GL1 to GLx are sequentially driven such that the potential of each gate line is set to a high level for a prescribed period of time once during one frame period. The potential of each of the clock lines CLK1 to CLKn is set to a high-level for a prescribed period of time twice during one frame period (times ta and tb). The potential of each of the reset lines RST1 to RSTn is set to a high-level for a prescribed period of time (reset period) once during one frame period (time ta). The read-out lines RWS1 to RWSn are divided into pairs of two, and the potentials of the respective (n/2) pairs of the read-out lines are sequentially set to a high level for a prescribed period of time after the time tc (read-out period).

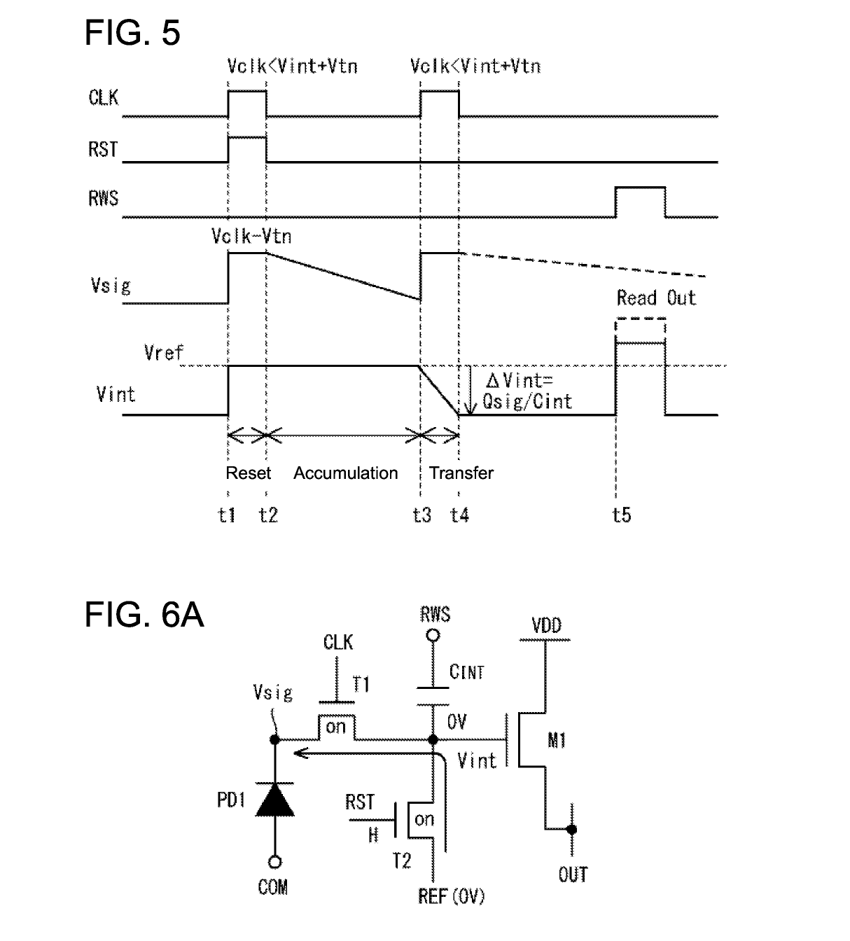

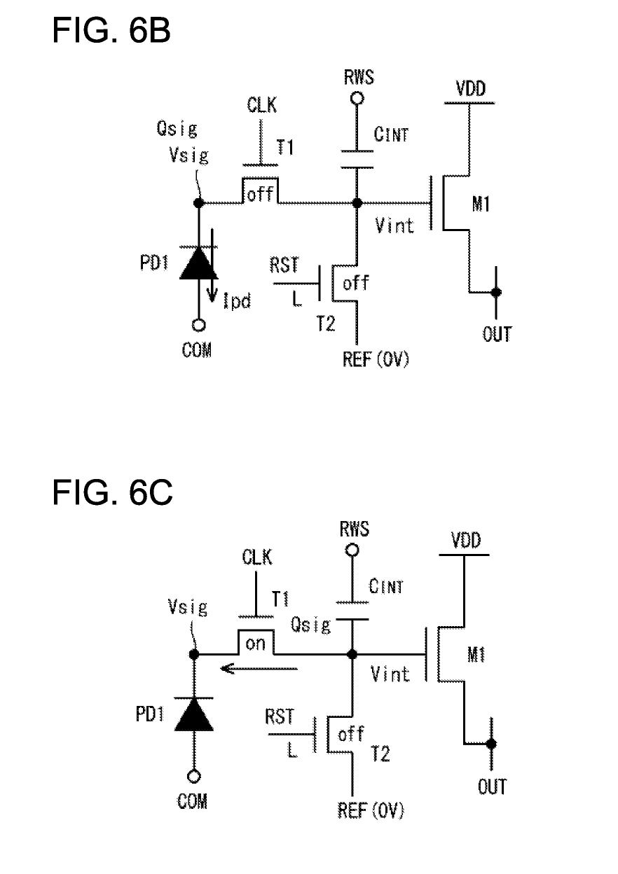

FIG. 5 is a waveform diagram showing changes in respective signals in the sensor pixel circuit 9 around the times ta to tc shown in FIG. 4. FIGS. 6A to 6C are schematic diagrams showing an operation of the sensor pixel circuit 9 when supplied with the driving signals shown in FIGS. 4 and 5.

In the reset period between times t1 and t2, when the clock signal CLK and the reset signal RST are set to a high level, as shown in FIG. 6A, the transistors T1 and T2 are both turned on. As a result of the transistor T2 being on, the potential Vint of the storage node INT becomes substantially the same as the reference voltage Vref (0V in this example). The high-level potential of the clock signal CLK is set such that the transistor T1 is operated in a saturation region.

That is, the following condition needs to be fulfilled, where Vclk is a high-level potential of the clock signal CLK, Vsig is a potential of a node SIG, and Vth is the threshold voltage of the transistor T1:

Vint−Vsig>Vclk−Vsig−Vth (1).

At the time t2, the reset signal RST is set to a low level from a high level, thereby ending the reset period and starting an accumulation period. During the accumulation period between the times t2 and t3, the clock signal CLK, the reset signal RST, and the read-out signal RWS are all maintained at a low level. During the accumulation period, the transistors T1 and T2 are off. In this state, when light enters the photodiode PD1, a current Ipd that corresponds to the incident light flows through the photodiode PD1, and charges Qsig are extracted from the node SIG (FIG. 6B). As a result, the potential Vsig of the node SIG is lowered by an amount corresponding to the extracted charges Qsig. Also, during the accumulation period, because the transistors T1 and T2 are off, the potential Vint at the storage node INT is maintained at the same level (Vref) as that in the reset period.

Next, at a point in time when the accumulation period ends (time t3), the clock signal CLK is set to a high level again, thereby turning the transistor T1 on. As a result, charges that correspond to the charges Qsig, which were extracted from the node SIG, are moved from the storage node INT to the node SIG. Consequently, the potential Vint at the storage node INT is lowered by ΔVint in accordance with the size of the charges Qsig, which results in the following equation:

$$\begin{matrix}Vint = Vref - Δ Vint \\ = Vref - Qsig / Cint \\ = Vref - Ipd \cdot t / Cint ,\end{matrix} \qquad ( 2 )$$

where Cint is a load capacitance of the storage node INT, and “t” is the length of the accumulation period (between the times t2 and t3).

In the read-out period following the time t5, the clock signal CLK and the reset signal RST are set to a low level, and the read-out signal RWS is set to a high level for reading-out. At this time, the potential Vint at the storage node INT is increased by an amount that is (Cint/Cp) times as much as the size increase in the potential of the read-out signal RWS (here, Cp is the total capacitance value of the sensor pixel circuit 9). The transistor M1 serves as a source follower amplifier circuit that uses, as a load, a transistor (not shown) included in the source driver circuit 6, and drives the output line OUT in accordance with the potential Vint.

The time t1 in FIG. 5 corresponds to the time to in FIG. 4, the time t3 corresponds to the time tb, and the time t5 corresponds to the time tc.

As described above, in this embodiment, the sensor pixel circuit 9a includes the transistor T2 for resetting, and a reset operation is performed during the reset period such that the transistor T1 is operated in a saturation region. Also, in the sensor pixel circuit 9a, the transistor T1 is disposed between the photodiode PD1 and the storage node INT, and therefore, it is possible to isolate the load capacitance of the photodiode PD1, which is relatively large, from the capacitor Cint, thereby achieving high sensitivity. The load capacitance of the photodiode PD1 is mainly accounted for by a capacitance formed between the photodiode PD1 and a light-shielding layer disposed on the rear surface of the photodiode PD1 (backlight side).

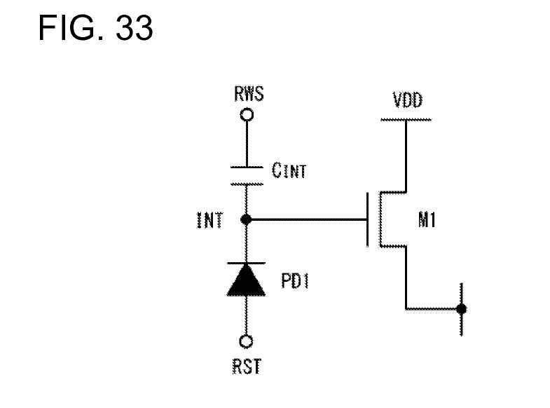

In the conventional sensor pixel circuit shown in FIG. 33, the amount of decrease ΔVint in potential Vint during the accumulation period is represented by the following equation, where Q is the accumulated charge at the cathode of the photodiode PD1, and Cpd is the load capacitance of the photodiode PD1:

ΔVint=Q/(Cint+Cpd) (3).

On the other hand, as shown in Equation (2) above, in the sensor pixel circuit 9a of this embodiment, ΔVint is not affected by the load capacitance Cpd of the photodiode PD1. Therefore, with the sensor pixel circuit 9a, the amount of decrease ΔVint during the accumulation period can be made larger, thereby achieving an optical sensor with higher sensitivity.

### MODIFICATION EXAMPLES OF EMBODIMENT 1

Embodiment 1 has been described above, but the sensor pixel circuit 9 can also be configured in different manners from the sensor pixel circuit 9a. Below, major modification examples will be described.

### Modification Example 1 of Embodiment 1

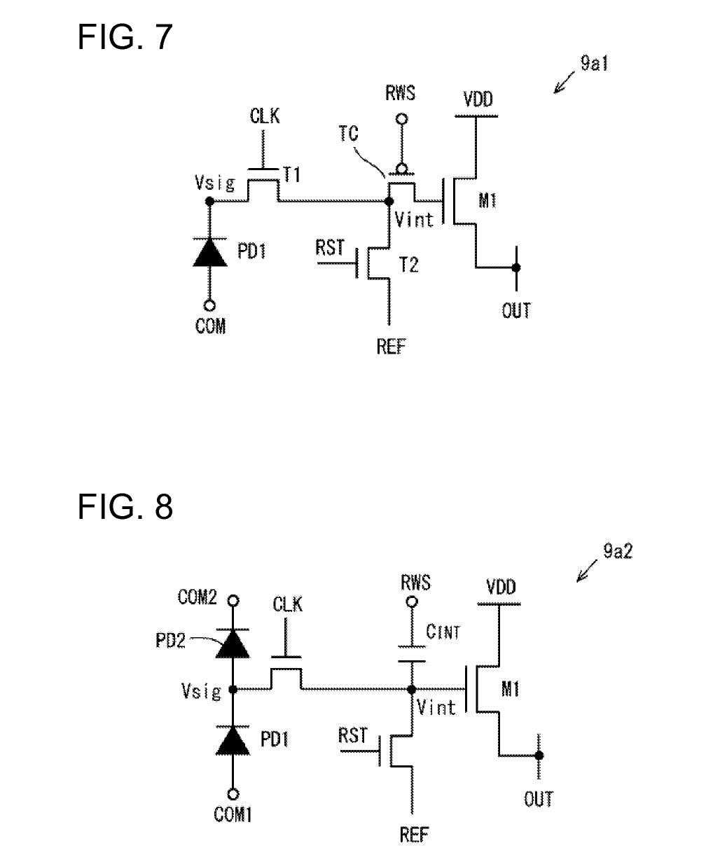

FIG. 7 is a circuit diagram showing a configuration of a sensor pixel circuit 9a1 as a modification example of the sensor pixel circuit 9a of Embodiment 1. As shown in FIG. 7, in the sensor pixel circuit 9a1, a transistor TC, which is a p-type TFT, is used as the capacitor C1. The drain of the transistor TC is connected to the drain of the transistor T1, the source is connected to the gate of the transistor M1, and the gate is connected to the read-out line RWS. With the transistor TC connected in this manner, when the read-out line RWS is applied with a high-level voltage for reading-out, a change in the potential Vint at the storage node can be made larger than that in the sensor pixel circuit 9a. Therefore, the difference between the potential Vint at the storage node when receiving high intensity light and the potential Vint at the storage node when receiving low intensity light can be amplified, which makes it possible to improve the sensitivity of the sensor pixel circuit.

### Modification Example 2 of Embodiment 1

FIG. 8 is a circuit diagram showing a configuration of a sensor pixel circuit 9a2 as a modification example of the sensor pixel circuit 9a of Embodiment 1. The sensor pixel circuit 9a2 shown in FIG. 8 is obtained by adding another photodiode PD2 to the sensor pixel circuit 9a. In FIG. 8, COM1 is a voltage that is supplied to the anode of the photodiode PD1. The photodiode PD2 is shielded from light, and serves as a reference optical sensor. The anode of the photodiode PD2 is connected to the cathode of the photodiode PD1 and to the source of the transistor T1, and the cathode thereof is applied with a fixed voltage COM2. The fixed voltage COM1 supplied to the anode of the photodiode PD1 and the fixed voltage COM2 supplied to the cathode of the photodiode PD2 are set so as to satisfy COM2>Vsig>COM1. In the configuration shown in FIG. 8, dark current flows through the photodiode PD2, with which a temperature compensation for the photodiodes is made possible.

### Modification Example 3 of Embodiment 1

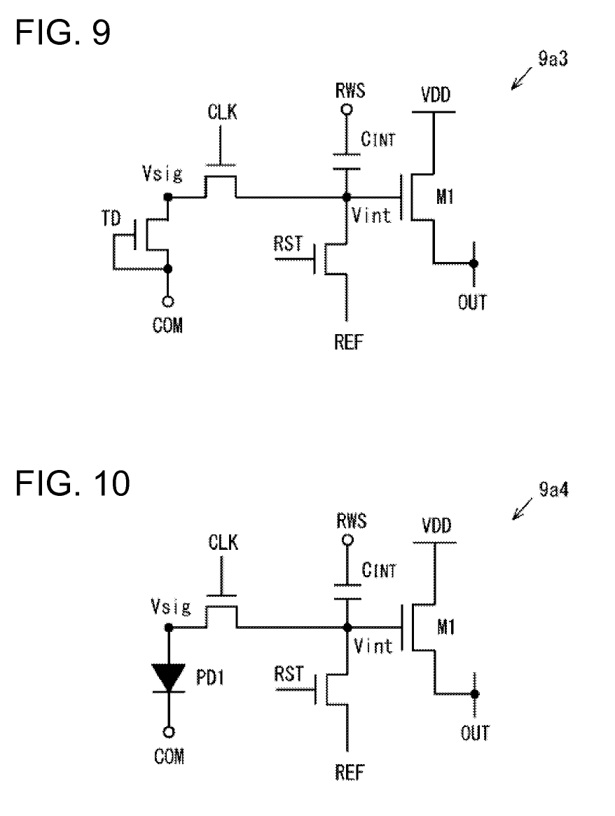

FIG. 9 is a circuit diagram showing a configuration of a sensor pixel circuit 9a3 as a modification example of the sensor pixel circuit 9a of Embodiment 1. In the sensor pixel circuit 9a3 shown in FIG. 9, the photodiode PD1 included in the sensor pixel circuit 9a is replaced with a phototransistor TD. This way, it is possible to constitute all of the transistors in the sensor pixel circuit 9a3 of N-type transistors. This allows the sensor pixel circuits to be manufactured by using a single channel process that manufactures N-type transistors only.

### Modification Example 4 of Embodiment 1

FIG. 10 is a circuit diagram showing a configuration of a sensor pixel circuit 9a4 as a modification example of the sensor pixel circuit 9a of Embodiment 1. In the sensor pixel circuit 9a4 shown in FIG. 10, the photodiode PD1 in the sensor pixel circuit 9a is connected in a reverse manner. The sensor pixel circuit 9a4 is applied with a reset signal RST that normally stays at a high level and that is set to a low level for resetting in the reset operation. The cathode of the photodiode PD1 is connected to the fixed voltage line COM, and the anode is connected to the source of the transistor T1. This way, a greater variation in pixel circuits can be obtained.

### Modification Example 5 of Embodiment 1

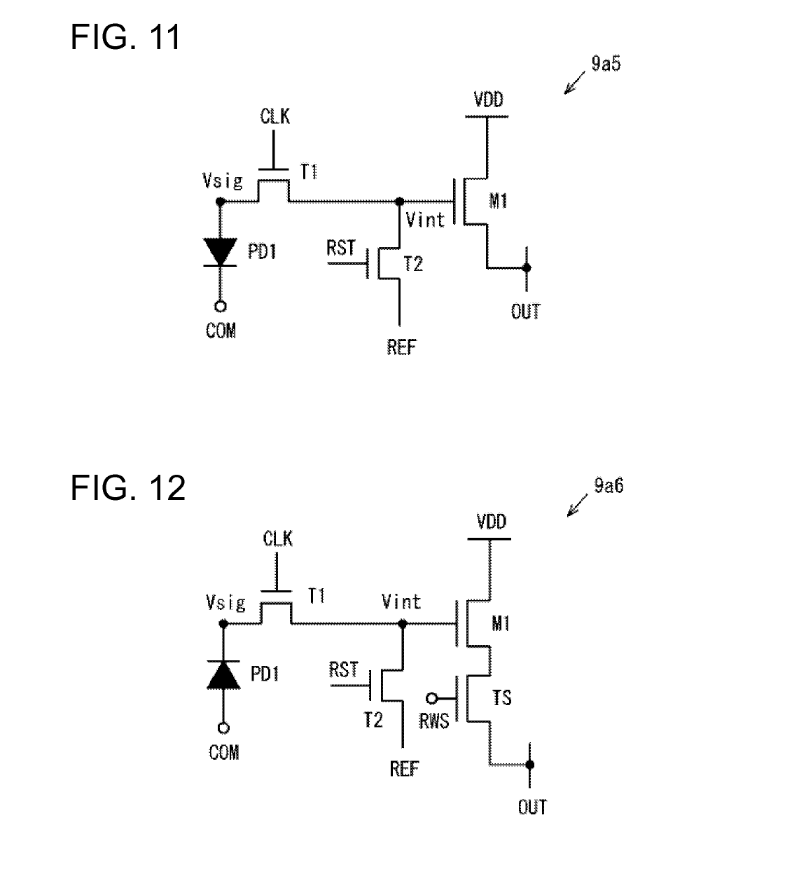

FIG. 11 is a circuit diagram showing a configuration of a sensor pixel circuit 9a5 as a modification example of the sensor pixel circuit 9a of Embodiment 1. In the sensor pixel circuit 9a5 shown in FIG. 11, the photodiode PD1 in the sensor pixel circuit 9a is connected in a reverse manner, and the capacitor C_{INT} is omitted. The read-out line RWS is also omitted from the sensor pixel circuit 9a5. In a manner similar to the sensor pixel circuit 9a4 of Modification Example 4 above, the sensor pixel circuit 9a5 is applied with a reset signal RST that normally stays at a high level and that is set to a low level for resetting in the reset operation. In the read-out operation, the reset signal RST is set to a high level for reading out. When the reset signal RST is set to a high level for reading out, the potential Vint at the storage node (gate potential of the transistor M1) rises, and a current that corresponds to the potential Vint at the storage node flows through the transistor M1. Because the capacitor C_{INT} is not provided in the sensor pixel circuit 9a5 as described above, the aperture ratio can be increased for the capacitor C_{INT}, and the sensitivity of the sensor pixel circuit can be improved.

### Modification Example 6 of Embodiment 1

FIG. 12 is a circuit diagram showing a configuration of a sensor pixel circuit 9a6 as a modification example of the sensor pixel circuit 9a of Embodiment 1. The sensor pixel circuit 9a6 shown in FIG. 12 is obtained by removing the capacitor C_{INT} from the sensor pixel circuit 9a, and adding a transistor TS thereto. The transistor TS is an N-type TFT, and functions as a select switching element. In the sensor pixel circuit 9a6, the source of the transistor M1 is connected to the drain of the transistor TS. The source of the transistor TS is connected to the output line OUT, and the gate thereof is connected to the read-out line RWS. This way, a greater variation in pixel circuits can be obtained. Also, because the capacitor C_{INT} is not provided, the aperture ratio can be increased for the capacitor C_{INT}, and the sensitivity of the sensor pixel circuit can be improved.

### Modification Example 7 of Embodiment 1

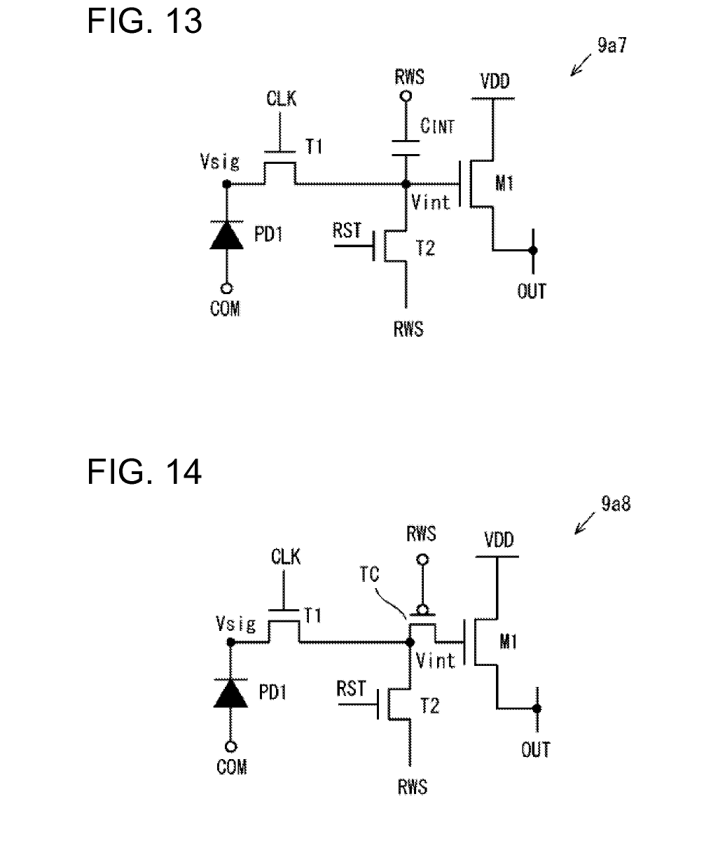

FIG. 13 is a circuit diagram showing a configuration of a sensor pixel circuit 9a7 as a variation of the sensor pixel circuit 9 of Embodiment 1. As shown in FIG. 13, the sensor pixel circuit 9a7 differs from the sensor pixel circuit 9a in that the source of the transistor T2 is connected to the read-out line RWS, instead of the power supply line REF that supplies the reference voltage Vref. With this sensor pixel circuit 9a7, the power supply line REF for the reference voltage becomes no longer necessary, thereby achieving an advantage of reducing the number of bus lines.

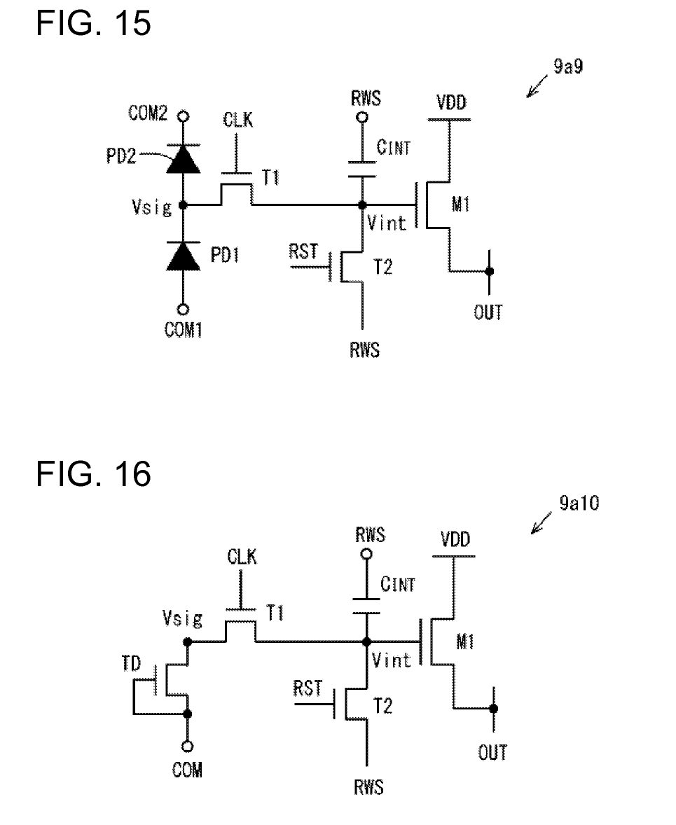

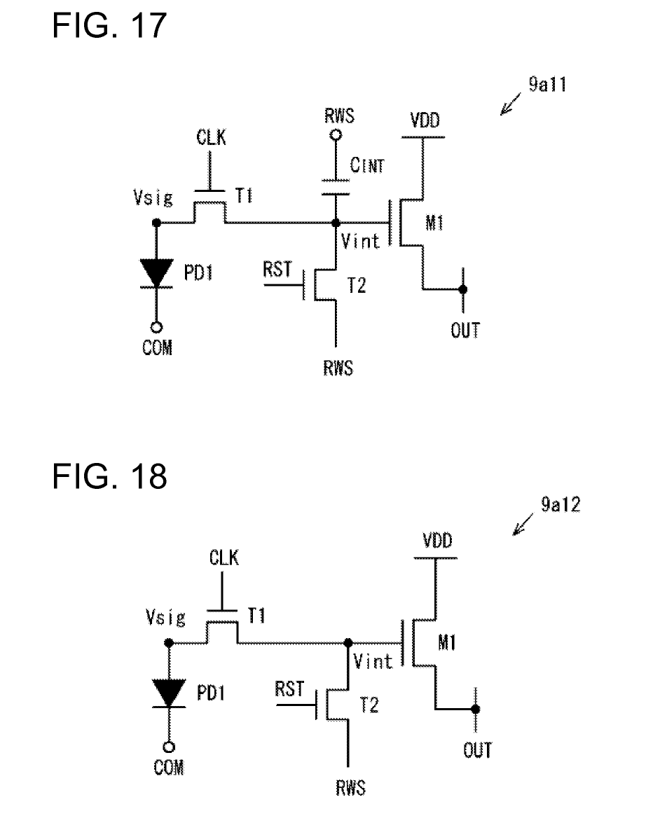

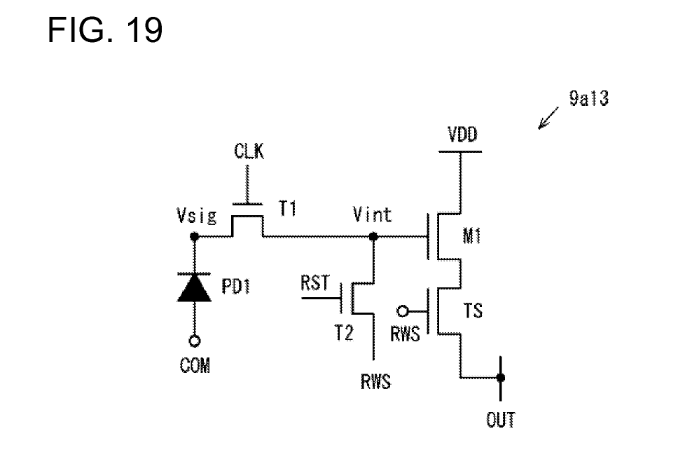

Also, as shown in FIGS. 14 to 19, circuit configurations 9a8 to 9a13 that respectively correspond to the above-mentioned sensor pixel circuits 9a1 to 9a6 (FIGS. 7 to 12), each of which is configured such that the source of the transistor T2 is connected to the read-out line RWS, instead of the power supply line REF that supplies the reference voltage Vref, can be employed as variations of the sensor pixel circuit 9. With these circuit configurations, in a manner similar to the sensor pixel circuit 9a7, the power supply line REF for the reference voltage becomes no longer necessary, thereby achieving an advantage of reducing the number of bus lines.

### Embodiment 2

Embodiment 2 of the display device of the present invention will be explained below. The same reference characters are given to elements similar to the constituting elements described in Embodiment 1, and the detailed descriptions thereof are omitted.

In Embodiment 2, the specific configuration of the sensor pixel circuit 9 is the same as that of the sensor pixel circuit 9a described in Embodiment 1, but the driving method thereof differs.

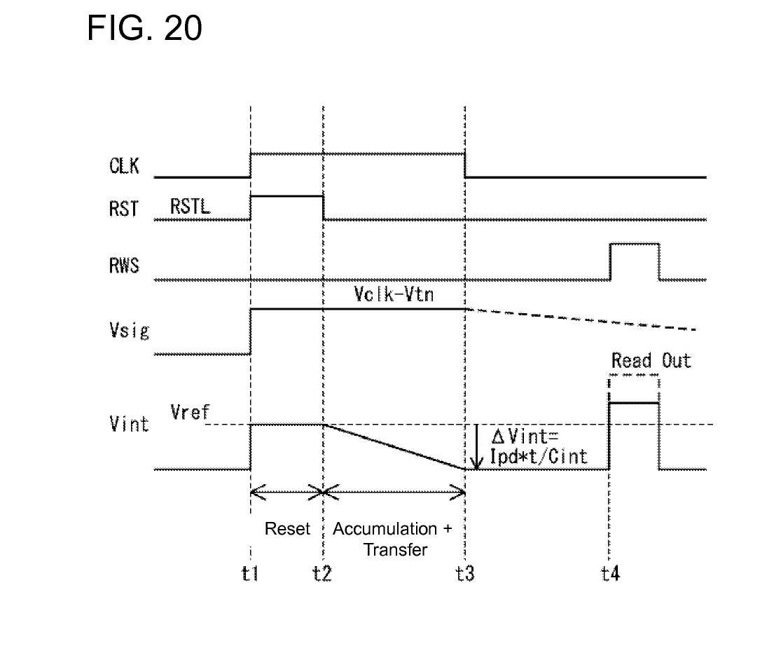

FIG. 20 is a waveform diagram showing driving signals applied to the sensor pixel circuits 9a in Embodiment 2 and changes in potentials at the node SIG and the storage node INT. As shown in FIG. 20, in Embodiment 2, the clock signal CLK is set to a high level only once during one frame period.

In a reset period between the times t1 and t2, the clock signal CLK and the reset signal RST are set to a high level, and the read-out signal RWS is set to a low level. At this time, the transistors T1 and T2 are both turned on. As a result, the potential Vsig at the node SIG and the potential Vint at the storage node INT are respectively reset to prescribed levels. That is, the potential Vint at the storage node INT is reset to the fixed voltage Vref, and the potential Vsig at the node SIG is reset to Vclk-Vth, respectively. The potential Vref is set to a greater value than the potential Vclk such that the transistor T1 is operated in a saturation region at all times.

In this embodiment, between the times t2 and t3, the accumulation of charges and the transfer of the charges to the storage node INT are simultaneously performed. During a period between the times t2 and t3, the clock signal CLK is maintained at a high level, and the reset signal RST and the read-out signal RWS are maintained at a low level, and as a result, the transistor T1 is turned on, and the transistor T2 is turned off. When light enters the photodiode PD1, photocurrent Ipd flows from the node SIG to the power supply line COM through the photodiode PD1, and the charges are extracted from the node SIG. At this time, because the transistor T1 is on, the charges extracted as a result of the photocurrent Ipd are made up for by charges at the storage node INT. Therefore, the potential Vint at the storage node INT is decreased by an amount that corresponds to the size of the charges. The amount of decrease ΔVint in potential Vint is represented by

ΔVint=Ipd·t/Cint (4),

where “t” is the length of the period between the times t2 and t3.

Thereafter, during the read-out period following the time t4, the clock signal CLK and the reset signal RST are set to a low level, and the read-out signal RWS is set to a high level for reading out. As a result, in a manner similar to Embodiment 1, the transistor M1 serves as a source follower amplifier circuit that uses, as a load, a transistor (not shown) included in the source driver circuit 6, and drives the output line OUT in accordance with the potential Vint of the storage node.

As described above, in this embodiment, the sensor pixel circuit 9a includes the transistor T2 for resetting, and a reset operation is performed during the reset period such that the transistor T1 is operated in a saturation region. Also, in the sensor pixel circuit 9a, the transistor T1 is disposed between the photodiode PD1 and the storage node INT, and therefore, it is possible to separate the load capacitance of the photodiode PD1, which is relatively large, from the capacitor Cint, thereby achieving high sensitivity.

### Modification Example of Embodiment 2

Embodiment 2 has been described above, but in a manner similar to Embodiment 1, even when the sensor pixel circuit 9a is replaced with any of the sensor pixel circuits 9a1 to 9a13 described in Embodiment 1, effects similar to above can be obtained.

### Embodiment 3

Embodiment 3 of the present invention will be explained below.

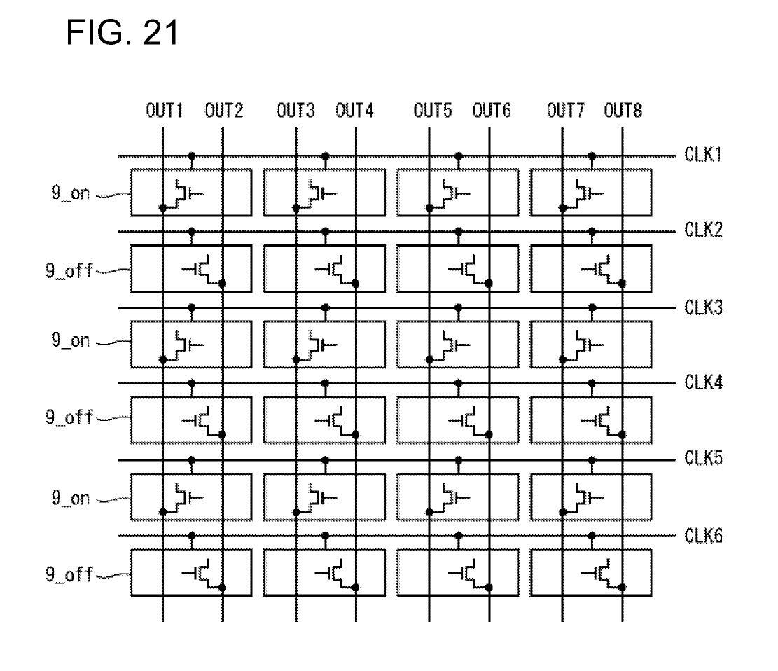

FIG. 21 is a diagram illustrating an arrangement of the sensor pixel circuits 9 in the pixel region 4 of the display device according to Embodiment 3. (n×m/2) number of sensor pixel circuits 9 include first sensor pixel circuits 9_on for detecting light that is received during an ON period of the backlight 3, and second sensor pixel circuits 9_off for detecting light that is received during an OFF period of the backlight 3. The number of the first sensor pixel circuits 9_on is the same as that of the second sensor pixel circuits 9_off. In FIG. 21, the (n×m/4) number of first sensor pixel circuits 9_on are provided near respective intersections of odd-numbered clock lines CLK1 to CLKn-1 and odd-numbered output lines OUT1 to OUTm-1. The (n×m/4) number of second sensor pixel circuits 9_off are provided near respective intersections of even-numbered clock lines CLK2 to CLKn and even-numbered output lines OUT2 to OUTm. As described above, the display panel 2 includes a plurality of output lines OUT1 to OUTm that transmit output signals of the first sensor pixel circuits 9_on and output signals of the second sensor pixel circuits 9_off. The first sensor pixel circuits 9_on and the second sensor pixel circuits 9_off are connected to mutually different output lines.

The source driver circuit 6 of this embodiment includes a differential circuit (not shown) that derives a difference between output signals from the first sensor pixel circuits 9_on and output signals from the second sensor pixel circuits 9_off. The source driver circuit 6 amplifies the difference in light amounts derived by the differential circuit, and outputs the amplified signal to the outside of the display panel 2 as a sensor output Sout. The sensor output Sout, as necessary, undergoes an appropriate process performed by the signal processing circuit 20 disposed outside the display panel 2.

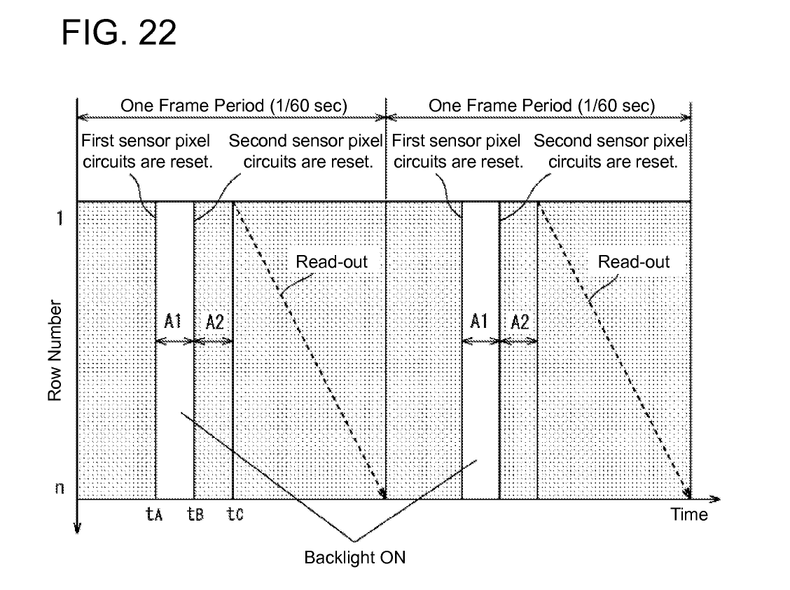

FIG. 22 is a diagram showing timing at which the backlight 3 is turned on and off, and timing at which the reset and read-out operations are conducted to the sensor pixel circuits 9. In the example in FIG. 22, the backlight 3 is turned on for a prescribed period of time once during one frame period, and remains off during the rest of the period. More specifically, the backlight 3 is turned on at a time tA in one frame period, and is turned off at a time tB. Also, at the time tA, all of the first sensor pixel circuits 9_on are reset, and at the time tB, all of the second sensor pixel circuits 9_off are reset.

The first sensor pixel circuits 9_on detect light that entered during a period A1 between the time tA and the time tB (ON period of the backlight 3). The second sensor pixel circuits 9_off detect light that entered during a period A2 between the time tB and the time tC (OFF period of the backlight 3). The period A1 has the same length as the period A2. The read-out operation from the first sensor pixel circuits 9_on and the read-out operation from the second sensor pixel circuits 9_off are performed in parallel with each other in a line-sequential manner after the time tC. In FIG. 22, the read-out operation from the sensor pixel circuits 9 is completed within one frame period, but the read-out operation can be carried over to the subsequent frame period as long as it ends before the reset operation for the first sensor pixel circuits 9_on is started. Although FIG. 22 shows an example in which the read-out operation for the sensor pixel circuits 9 is performed once during one frame period, the read-out operation for the sensor pixel circuits 9 may also be performed twice or more during one frame period.

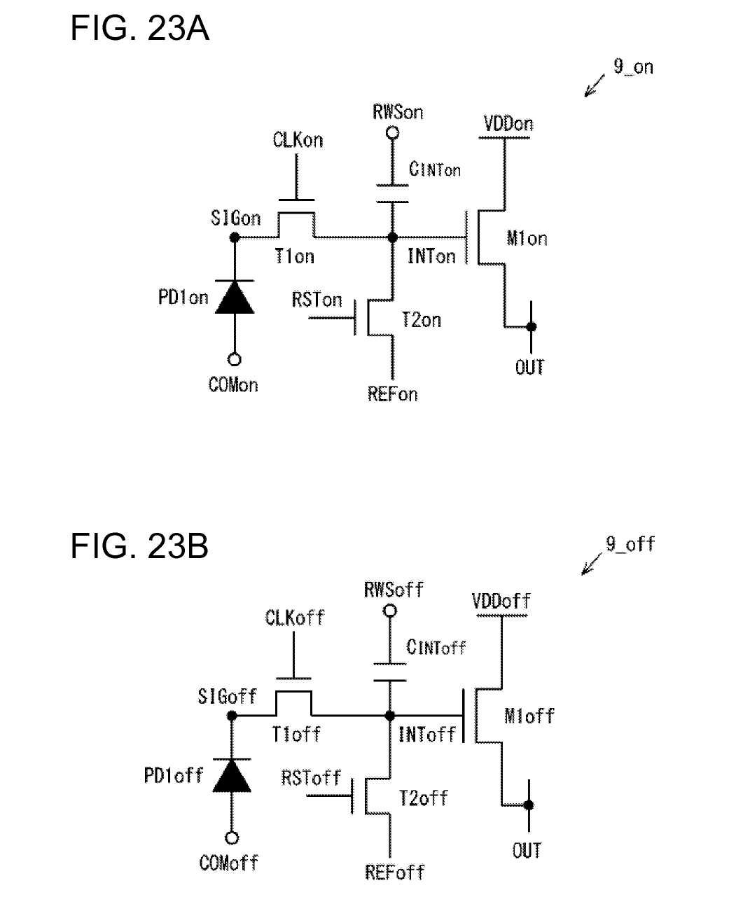

FIGS. 23A and 23B are circuit diagrams showing examples of specific configurations of the first sensor pixel circuit 9_on and the second sensor pixel circuit 9_off. As shown in FIGS. 23A and 23B, the first pixel circuit 9_on and the second pixel circuit 9_off respectively have the same circuit configuration as that of the sensor pixel circuit 9a described in Embodiment 1.

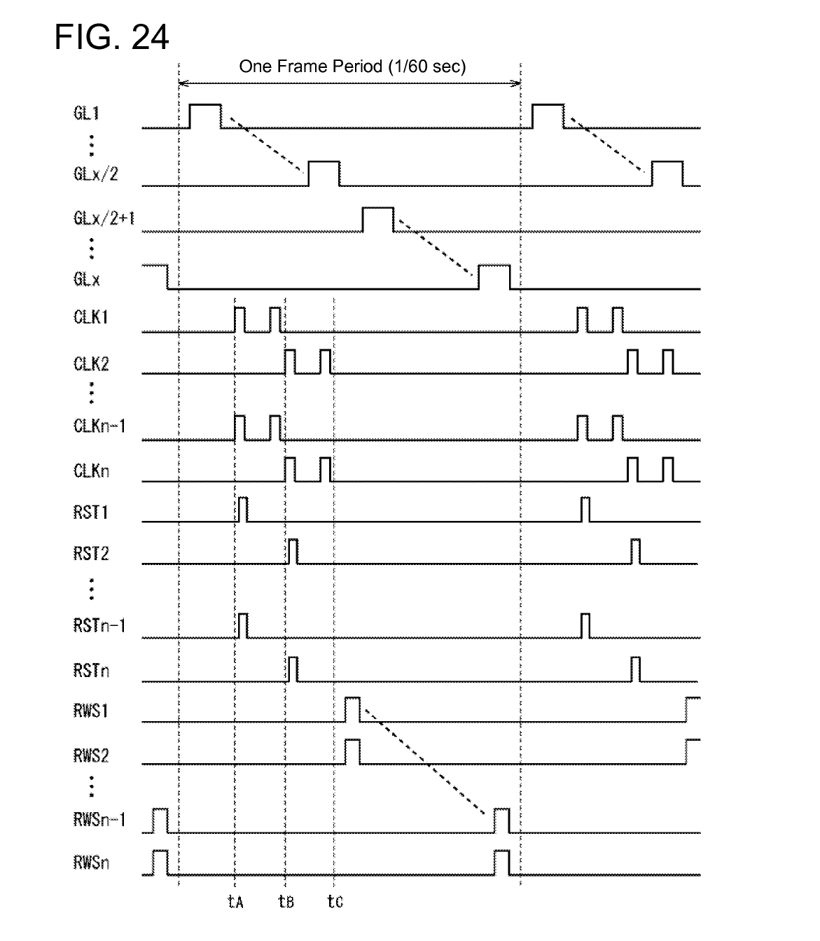

FIG. 24 is a signal waveform diagram of the display panel 2 of this embodiment. As shown in FIG. 24, the gate lines GL1 to GLx are sequentially driven such that the potential of each line is set to a high level for a prescribed period of time once during one frame period. The potential of each of the odd-numbered clock lines CLK1 to CLKn-1 is set to a high level for a prescribed period of time twice in the period A1 during one frame period. The potential of each of the even-numbered clock lines CLK2 to CLKn is set to a high level for a prescribed period of time twice in the period A2 during one frame period. The potential of each of the odd-numbered reset lines RST1 to RSTn-1 is set to a high level for a prescribed period of time once during one frame period in the beginning of the period A1. The potential of each of the even-numbered reset lines RST2 to RSTn is set to a high level for a prescribed period of time once during one frame period in the beginning of the period A2. The read-out lines RWS1 to RWSn are divided into pairs of two, and the potentials of the respective (n/2) pairs of the read-out lines are sequentially set to a high level for a prescribed period of time after the time tC.

The high-level potential Vclk of the clock lines CLK is set to fulfill the condition represented by Inequality (1) in Embodiment 1. The operation of the first sensor pixel circuit 9_on in the period A1 and the operation of the second sensor pixel circuit 9_off in the period A2 are the same as that of the sensor pixel circuit 9a described in Embodiment 1.

As described above, in this embodiment, the potential Vint_on at the storage node INTon of the first sensor pixel circuit 9_on in the period A1 can be represented as follows:

Vint_on=Vref−Ipd_on·t/Cint (5),

in a manner similar to Equation (2) in Embodiment 1. Here, “Ipd_on” represents a current value of a photocurrent that flows through the photodiode PD1 during the accumulation period in which the backlight 3 is ON (accumulation period in the period A1).

The potential Vint_off at the storage node INToff of the second sensor pixel circuit 9_off in the period A2 can be represented as follows:

Vint_off=Vref−Ipd_off·t/Cint (6),

in a manner similar to Equation (2) in Embodiment 1. Here, “Ipd_off” represents a current value of a photocurrent that flows through the photodiode PD1 during the accumulation period in which the backlight 3 is OFF (accumulation period in the period A2).

During the read-out period after the time tC shown in FIG. 24, as described above, sensor signals that correspond to the amount of light that entered during the detection period in which the backlight 3 is ON are read out from the first sensor pixel circuits 9_on, and sensor signals that correspond to the amount of light that entered during the detection period in which the backlight 3 is OFF are read out from the second sensor pixel circuits 9_off, respectively. The differential circuit in the source driver circuit 6 derives the difference between the output signals from the first sensor pixel circuits 9_on and the output signals from the second sensor pixel circuits 9_off, thereby obtaining the difference between the amount of light received during the backlight ON period and the amount of light received during the backlight OFF period.

The output signals from the second sensor pixel circuits 9_off, that is, the sensor signals that correspond to the amount of light that entered during the detection period in which the backlight 3 is OFF only includes noise components generated as a result of the surrounding environment. Therefore, in the differential circuit of the source driver circuit 6, by subtracting the output signals of the second sensor pixel circuits 9_off from the output signals of the first sensor pixel circuits 9_on, it is possible to obtain highly accurate sensor output from which noise components have been removed.

In a manner similar to the sensor pixel circuits 9a of Embodiment 1, with the first sensor pixel circuits 9_on and the second sensor pixel circuits 9_off, the amount of decrease ΔVint in potential at the storage node during the accumulation period is not affected by the load capacitance Cpd of the photodiode PD1. Therefore, with this embodiment, it is possible to achieve optical sensors having high sensitivity.

### Modification Example of Embodiment 3

In Embodiment 3 described above, in a manner similar to Embodiment 1, the sensor pixel circuits 9a1 to 9a13 described in Embodiment 1 may be adopted as the circuit configuration of the first sensor pixel circuit 9_on and the second sensor pixel circuit 9_off, instead of the sensor pixel circuit 9a, and even with these circuit configurations, effects similar to above can be obtained.

It is also possible to adopt the following modification example.

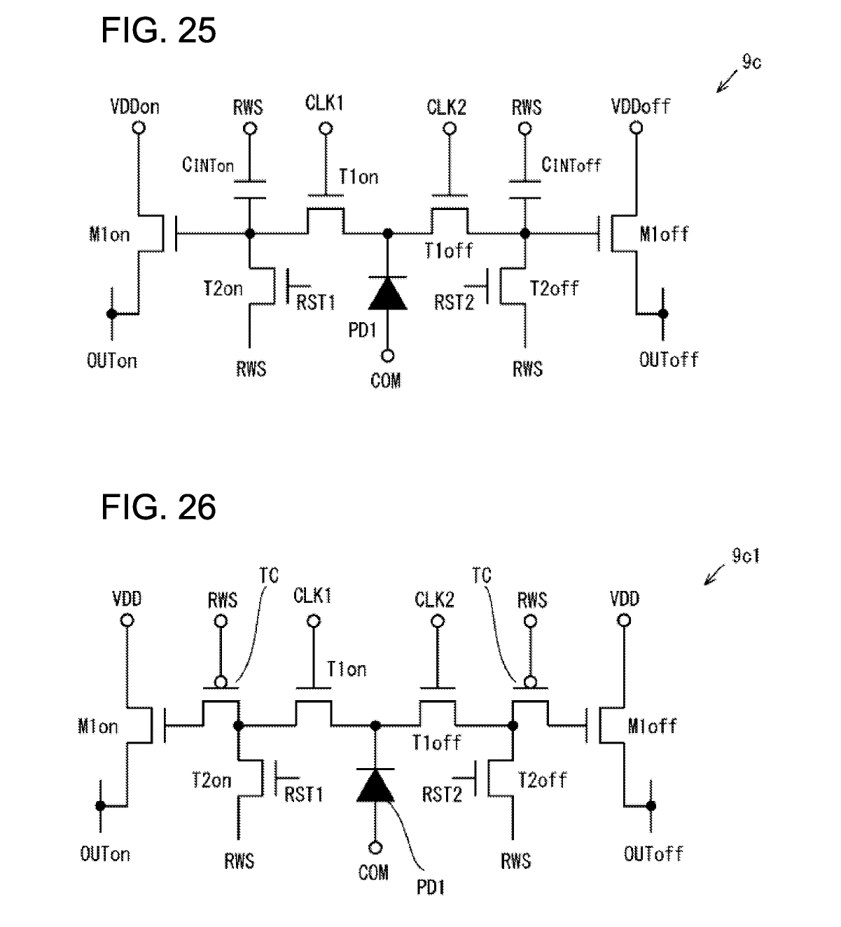

FIG. 25 is a circuit diagram of a sensor pixel circuit 9c of Embodiment 3. The sensor pixel circuit 9c shown in FIG. 25 includes transistors T1on, T1off, T2on, T2off, M1on, M1off, a photodiode PD1, and capacitors Cinton, Cintoff. The transistors T1on, T1off, T2on, T2off, M1on, and M1off are N-type TFTs. In the sensor pixel circuit 9c shown in FIG. 25, the photodiode PD1 and the circuit elements on the left side correspond to the first sensor pixel circuit that obtains a sensor output based on the accumulation period during which the backlight is ON. The photodiode PD1 and the circuit elements on the right side correspond to the second sensor pixel circuit that obtains a sensor output based on the accumulation period during which the backlight is OFF. That is, the sensor pixel circuit 9c functions as both the sensor pixel circuit 9_on and the sensor pixel circuit 9_off described above. The sensor pixel circuit 9c is connected to clock lines CLKon, CLKoff, reset lines RSTon, RSToff, a read-out line RWS, power supply lines VDDon, VDDoff, and output lines OUTon, OUToff.

As shown in FIG. 25, the anode of the photodiode PD1 is connected to the fixed voltage supply COM, and the cathode is connected to the source of each of the transistors T1on and T1off. The gate of the transistor T1on is connected to the clock line CLK1, and the drain is connected to the gate of the transistor M1on. The drain of the transistor M1on is connected to the power supply line VDDon, and the source is connected to the output line OUTon. The capacitor C1on is disposed between the gate of the transistor M1on and the read-out line RWS. The gate of the transistor T1off is connected to the clock line CLK2, and the drain is connected to the gate of the transistor M1off. The drain of the transistor M1off is connected to the power supply line VDDoff, and the source is connected to the output line OUToff. The capacitor CINToff is disposed between the gate of the transistor M1off and the read-out line RWS. In the sensor pixel circuit 9c, the node connected to the gate of the transistor M1on is the first storage node, and the node connected to the gate of the transistor M1off is the second storage node. The transistors M1on and M1off function as read-out transistors.

In this configuration, the sensor pixel circuit 9c can be driven by the driving signals shown in FIG. 24, and in a manner similar to Embodiment 3, by subtracting the output signal of the output line OUToff from the output signal of the output line OUTon, it is possible to obtain highly accurate sensor output from which noise components have been removed.

In a manner similar to the sensor pixel circuit 9a of Embodiment 1, with the sensor pixel circuit 9c of this modification example, the amount of decrease ΔVint in potential at the storage node during the accumulation period is not affected by the load capacitance Cpd of the photodiode PD1. Therefore, with this embodiment, it is possible to achieve optical sensors having high sensitivity.

It is also possible to modify the sensor pixel circuit 9c shown in FIG. 25 in manners similar to the sensor pixel circuits 9a1 to 9a6 that are the modification examples of the sensor pixel circuit 9a in Embodiment 1. These modification examples will be explained below.

FIG. 26 is a circuit diagram showing a configuration of a sensor pixel circuit 9c1 as a modification example of the sensor pixel circuit 9c. In the sensor pixel circuit 9c1 shown in FIG. 26, transistors TC, which are p-type TFTs, are used instead of the capacitors C_{INT} in the sensor pixel circuit 9c. The drain of each transistor TC is connected to the drain of each transistor T1, the source is connected to the gate of each transistor M1, and the gate is connected to a read-out line RWS. With the transistors TC connected in this manner, when the read-out line RWS is applied with a high-level voltage for reading-out, a change in the potential Vint at the storage node can be made larger than that in the sensor pixel circuit 9a. Therefore, the difference between the potential Vint at the storage node when receiving high intensity light and the potential Vint at the storage node when receiving low intensity light can be amplified, which makes it possible to improve the sensitivity of the sensor pixel circuit.

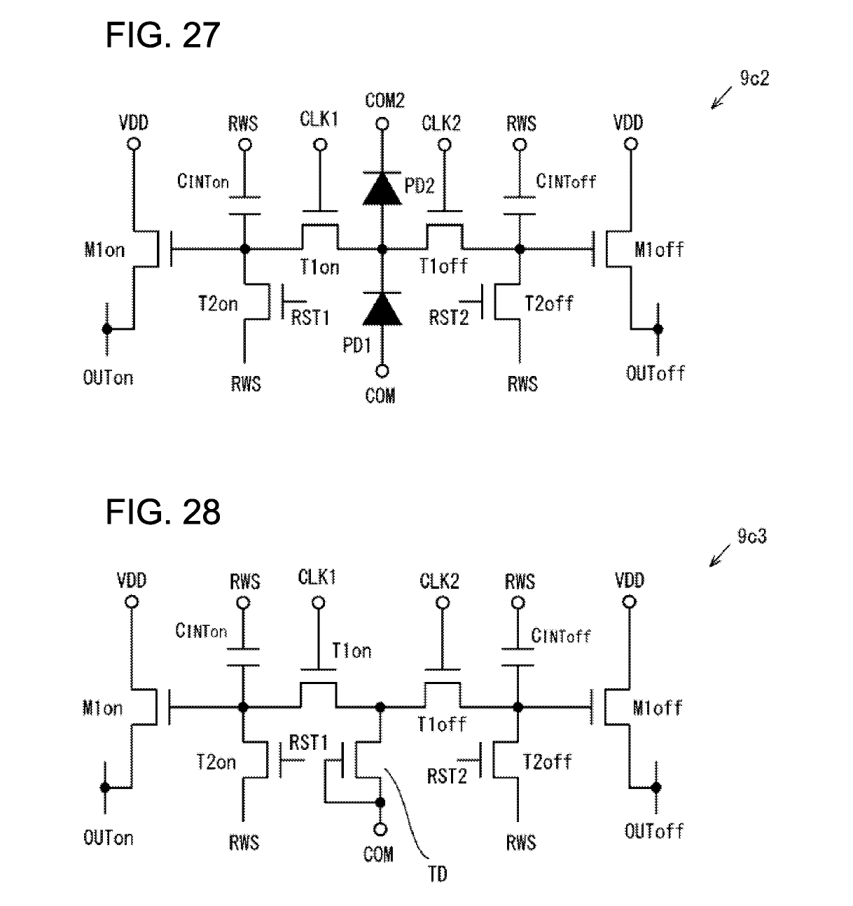

FIG. 27 is a circuit diagram showing a configuration of a sensor pixel circuit 9c2 as a modification example of the sensor pixel circuit 9c. The sensor pixel circuit 9c2 shown in FIG. 27 is obtained by adding another photodiode PD2 to the sensor pixel circuit 9c. The photodiode PD2 is shielded from light, and serves as a reference optical sensor. The anode of the photodiode PD2 is connected to the cathode of the photodiode PD1 and to the source of each of the transistors T1on and T1off, and the cathode thereof is applied with a fixed voltage COM2. Because a dark current flows through the photodiode PD2, the photodiode PD2 can be used for temperature compensation of the photodiodes. In FIG. 27, the fixed voltage COM supplied to the anode of the photodiode PD1 and the fixed voltage COM2 supplied to the cathode of the photodiode PD2 are set so as to satisfy COM2>(potential between the diodes PD1 and PD2)>COM.

FIG. 28 is a circuit diagram showing a configuration of a sensor pixel circuit 9c3 as a modification example of the sensor pixel circuit 9c. In the sensor pixel circuit 9c3 shown in FIG. 28, the photodiode PD1 included in the sensor pixel circuit 9c is replaced with a phototransistor TD. This way, it is possible to constitute all of the transistors included in the sensor pixel circuit 9c3 of N-type transistors. This allows the sensor pixel circuits to be manufactured by using a single channel process that manufactures N-type transistors only.

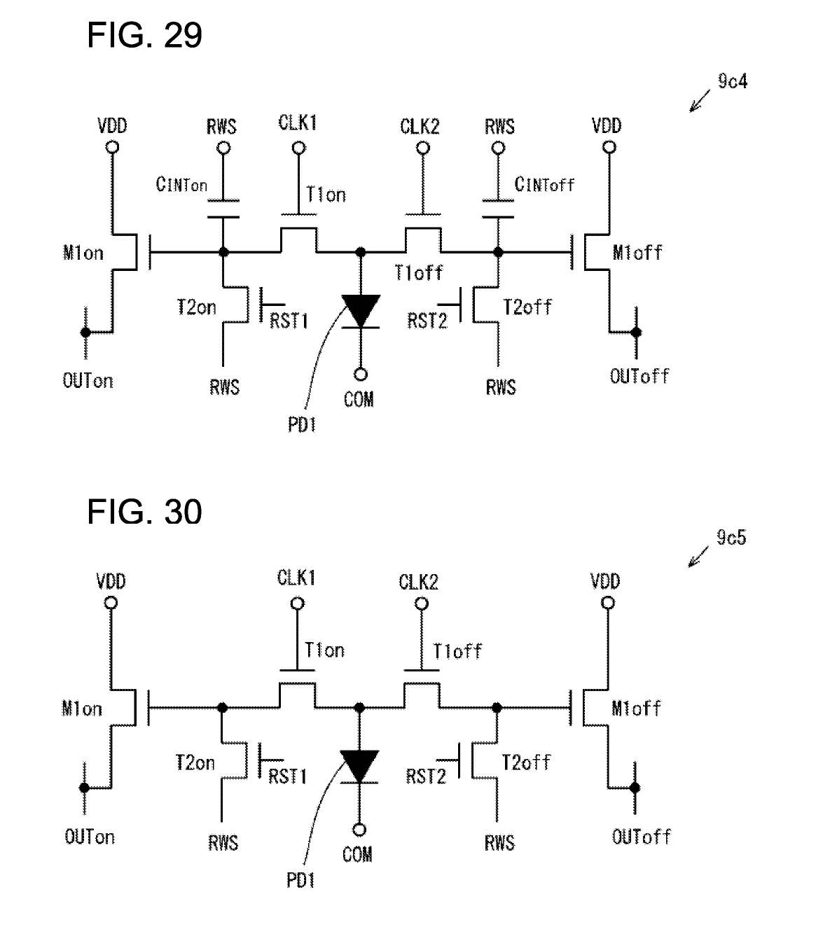

FIG. 29 is a circuit diagram showing a configuration of a sensor pixel circuit 9c4 as a modification example of the sensor pixel circuit 9c. In the sensor pixel circuit 9c4 shown in FIG. 29, the photodiode PD1 in the sensor pixel circuit 9c is connected in a reverse manner. The sensor pixel circuit 9c4 is supplied with a reset signal RST that normally stays at a high level and that is set to a low level for resetting in the reset operation. The cathode of the photodiode PD1 is connected to the fixed voltage line COM, and the anode is connected to the source of each of the transistors T1on, T1off. This way, a greater variation in pixel circuits can be obtained.

FIG. 30 is a circuit diagram showing a configuration of a sensor pixel circuit 9c5 as a modification example of the sensor pixel circuit 9c. In the sensor pixel circuit 9c5 shown in FIG. 30, the photodiode PD1 in the sensor pixel circuit 9c is connected in a reverse manner, and the capacitor C_{INT} is omitted. In a manner similar to the sensor pixel circuit 9c4 shown in FIG. 29, the sensor pixel circuit 9c5 is supplied with a reset signal RST that normally stays at a high level and that is set to a low level for resetting in the reset operation. In the read-out operation, the reset signal RST is set to a high level for reading out. When the reset signal RST is set to a high level for reading out, the potential Vint at the storage node (gate potential of the transistor M1) rises, and a current that corresponds to the potential Vint at the storage node flows through the transistor M1. Because the capacitor C_{INT} is not provided in the sensor pixel circuit 9c5, the aperture ratio can be increased for the capacitor C_{INT}, and the sensitivity of the sensor pixel circuit can be improved.

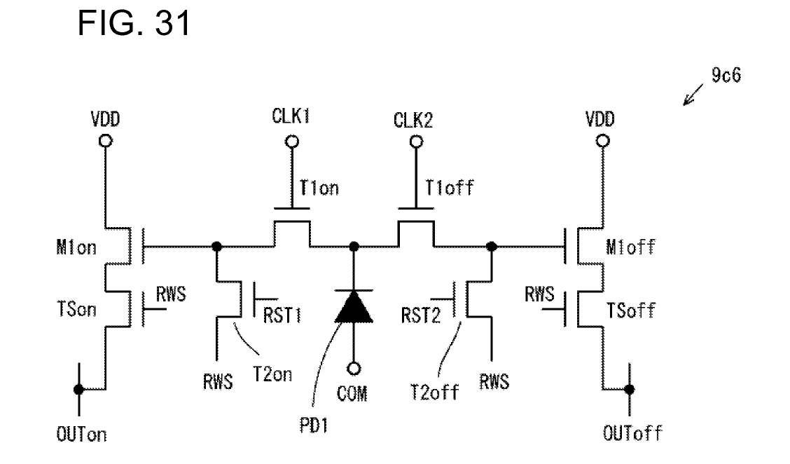

FIG. 31 is a circuit diagram showing a configuration of a sensor pixel circuit 9c6 as a modification example of the sensor pixel circuit 9c. The sensor pixel circuit 9c6 shown in FIG. 31 is obtained by removing the capacitors C_{INT} from the sensor pixel circuit 9c, and adding transistors TSon and TSoff thereto. The transistors TSon and TSoff are N-type TFTs, and function as select switching elements. In the sensor pixel circuit 9c6, the respective sources of the transistors M1on and M1off are connected to the respective drains of the transistors TSon and TSoff. The sources of the transistors TSon and TSoff are connected to the output lines OUTon and OUToff, respectively, and the gates thereof are connected to the read-out lines RWS. This way, a greater variation in pixel circuits can be obtained. Also, because the capacitor C_{INT} is not provided, the aperture ratio can be increased for the capacitor C_{INT}, and the sensitivity of the sensor pixel circuit can be improved.

As described above, the sensor pixel circuit 9c and the sensor pixel circuits 9c1 to 9c6 as modification examples thereof have a configuration in which the first sensor pixel circuit, which obtains a sensor output based on the accumulation period in which the backlight 3 is on, and the second sensor pixel circuit, which obtains a sensor output based on the accumulation period in which the backlight 3 is off, share a single photodiode PD1 (light-receiving element). The cathode of the shared photodiode PD1 is connected to the source of the transistor T1on included in the portion that corresponds to the first pixel circuit, and to the source of the transistor T1off in the portion that corresponds to the second pixel circuit.

With the sensor pixel circuit 9c, it is possible to detect the amount of light during the backlight ON period and the amount of light during the backlight OFF period. Also, because a single photodiode PD1 is shared by the first sensor pixel circuit, which obtains a sensor output based on the accumulation period in which the backlight 3 is on, and the second sensor pixel circuit, which obtains a sensor output based on the accumulation period in which the backlight 3 is off, effects of variations in sensitivity characteristics of the photodiodes can be eliminated. As a result, it is possible to obtain the difference between the amount of light received during the backlight ON period and the amount of light received during the backlight OFF period with high degree of accuracy. Also, because the number of photodiodes is reduced, the aperture ratio can be improved, thereby making it possible to increase the sensitivity of the sensor pixel circuit.

### Embodiment 4

Embodiment 4 of the present invention will be explained below.

A display device according to Embodiment 4 has the first sensor pixel circuits 9_on and the second sensor pixel circuits 9_off respectively shown in FIGS. 23A and 23B in Embodiment 3 as the sensor pixel circuits 9. Also, in this embodiment, the timing at which the backlight 3 is turned on and off is the same as that of Embodiment 3 (see FIG. 22).

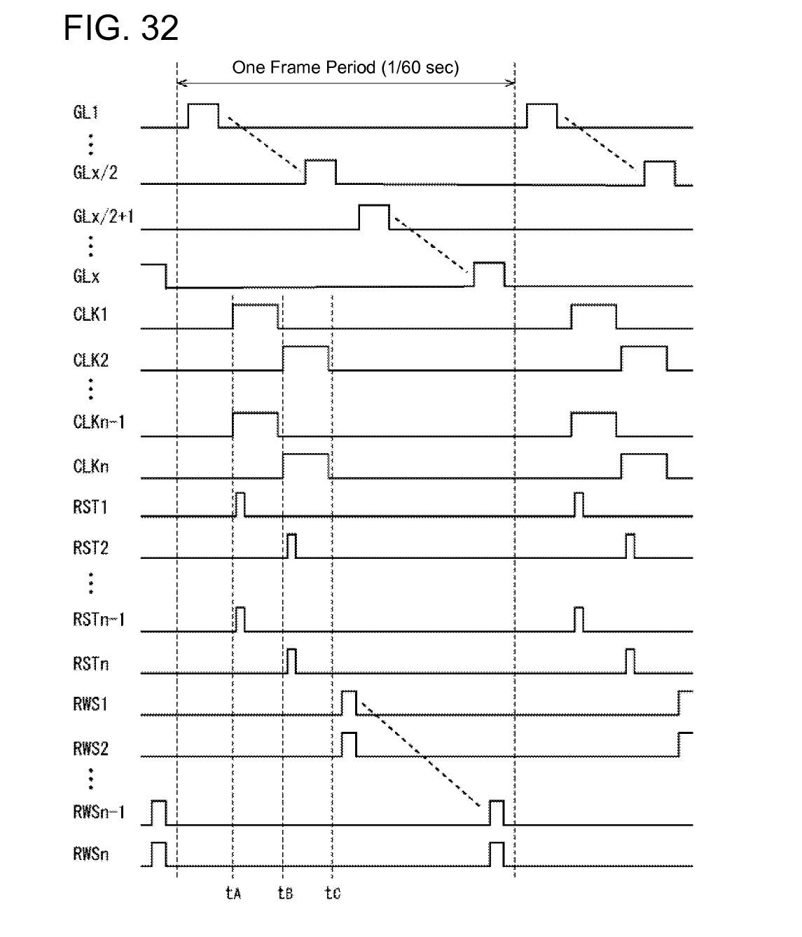

FIG. 32 is a signal waveform diagram of the display panel 2 of this embodiment. The display device of Embodiment 4 differs from that of Embodiment 3 in the timing of the clock signal CLK. That is, in this embodiment, the potential of each of the odd-numbered clock lines CLK1 to CLKn-1 is set to a high level for a prescribed period of time once in the period A1 during one frame period. The potential of each of the even-numbered clock lines CLK2 to CLKn is set to a high level for a prescribed period of time once in the period A2 during one frame period. The timing of the reset signal RST and the read-out signal RWS is the same as that of Embodiment 3.

The high level potential Vclk of the clock line CLK and the reference potential Vref are set to fulfill the same conditions as those in Embodiment 2. The operation of the first sensor pixel circuit 9_on in the period A1 and the operation of the second sensor pixel circuit 9_off in the period A2 are the same as those in Embodiment 2.

According to this embodiment, in the read-out period after the time tC shown in FIG. 32, sensor signals that correspond to the amount of light that entered during the detection period in which the backlight 3 is on are read out from the first sensor pixel circuits 9_on, and sensor signals that correspond to the amount of light that entered during the detection period in which the backlight 3 is off are read out from the second sensor pixel circuits 9_off, respectively. The differential circuit in the source driver circuit 6 derives the difference between the output signals from the first sensor pixel circuits 9_on and the output signals from the second sensor pixel circuits 9_off, thereby obtaining the difference between the amount of light received during the backlight ON period and the amount of light received during the backlight OFF period.

The output signals from the second sensor pixel circuits 9_off, that is, the sensor signals that correspond to the amount of light that entered during the detection period in which the backlight 3 is off only include noise components generated as a result of the surrounding environment. Therefore, by subtracting the output signals of the second sensor pixel circuits 9_off from the output signals of the first sensor pixel circuits 9_on in the differential circuit of the source driver circuit 6, it is possible to obtain highly accurate sensor output from which noise components have been removed.

In a manner similar to the sensor pixel circuits 9a of Embodiment 1, with the first sensor pixel circuits 9_on and the second sensor pixel circuits 9_off of this embodiment, the amount of decrease ΔVint in potential at the storage node during the accumulation period is not affected by the load capacitance Cpd of the photodiode PD1. Therefore, with this embodiment, it is possible to achieve optical sensors having high sensitivity.

### Modification Example of Embodiment 4

In Embodiment 4 described above, in a manner similar to Embodiment 1, the sensor pixel circuits 9a1 to 9a13 described in Embodiment 1 may be adopted as circuit configurations of the first sensor pixel circuits 9_on and the second sensor pixel circuits 9_off, instead of the sensor pixel circuit 9a, and even with those circuit configurations, effects similar to above can be obtained.

Alternatively, even when the first sensor pixel circuit 9_on and the second sensor pixel circuit 9_off are replaced with the sensor pixel circuit 9c described in Embodiment 3, effects similar to above can be obtained. It is also possible to adopt the sensor pixel circuits 9c1 to 9c6 that are modification examples of the sensor pixel circuit 9c.

### OTHER MODIFICATION EXAMPLES

In the driving method described in Embodiments 3 and 4, during one frame period, OFF signals are obtained first, and then the ON signals are obtained. However, it is also possible to adopt a driving method in which ON signals are obtained first, and then OFF signals are obtained.

### INDUSTRIAL APPLICABILITY

The present invention has an industrial applicability as a display device having an optical sensor function.

1. A display device, comprising:
a display panel that includes a plurality of display pixel circuits and a plurality of sensor pixel circuits in a display region; and
a driver circuit that supplies a driving signal to the sensor pixel circuits,
wherein each of the sensor pixel circuits comprises:
a light-receiving element;
a first storage node that accumulates electrical charges corresponding to an amount of light that entered the light-receiving element;
a second storage node that is provided to retain electrical charges at the first storage node;
a read-out switching element that is connected to the second storage node;
a first switching element that is connected between the first storage node and the second storage node, the first switching element being operated in a saturation region when electrical charges accumulated in the first storage node are transferred to the second storage node; and
a second switching element that is connected to the second storage node, the second switching element being provided for resetting the first and second storage nodes.

2. The display device according to claim 1,
wherein each of the sensor pixel circuits further comprises a capacitor that is connected between the second storage node and a read-out signal line, and
wherein the second switching element has a gate connected to a reset line, a source connected to a fixed voltage source, and a drain connected to the second storage node.

3. The display device according to claim 1,
wherein each of the sensor pixel circuits further comprises a capacitor that is connected between the second storage node and a read-out signal line, and
wherein the second switching element has a gate connected to a reset line, a source connected to the read-out signal line, and a drain connected to the second storage node.

4. The display device according to claim 1,
wherein the driver circuit performs a sensing operation during a unit period that includes:
a reset period during which the first switching element is turned on, the second switching element is turned on, and the first and second storage nodes are reset;
an accumulation period during which the first switching element is turned off, the second switching element is turned off, and electrical charges corresponding to an amount of light received by the light-receiving element are accumulated in the first storage node;
a transfer period during which the first switching element is turned on, the second switching element is turned off, and electrical charges that were accumulated in the first storage node during the accumulation period are transferred to the second storage node; and
a read-out period during which the first switching element is turned off, the second switching element is turned off, and the read-out switching element is turned on, thereby performing a read-out operation.

5. The display device according to claim 1,
wherein the driver circuit performs a sensing operation during a unit period that includes:
a reset period during which the first switching element is turned on, the second switching element is turned on, and the first and second storage nodes are reset;
an accumulation and transfer period during which the first switching element is turned on, the second switching element is turned off, and electrical charges corresponding to an amount of light received by the light-receiving element are accumulated in the first storage node, while transferring electrical charges that were accumulated in the first storage node during the accumulation period to the second storage node; and
a read-out period during which the first switching element is turned off, the second switching element is turned off, and the read-out switching element is turned on, thereby performing a read-out operation.

6. The display device according to claim 1, further comprising a light source that is turned on only for a prescribed period of time in one frame period,
wherein the sensor pixel circuits include a first sensor pixel circuit and a second sensor pixel circuit, the first sensor pixel circuit detecting light during a detection period in which the light source is on, the second sensor pixel circuit detecting light during a detection period in which the light source is off, and
wherein the driver circuit performs a read-out operation for the first and second sensor pixel circuits in a line-sequential manner during a period other than the detection period in which the light source is on and the detection period in which the light source is off.

7. The display device according to claim 6,
wherein the light source is turned on for a prescribed period of time only once during one frame period, and
wherein one frame period includes one detection period in which the light source is on and one detection period in which the light source is off.

8. The display device according to claim 6,
wherein the first sensor pixel circuit and the second sensor pixel circuit share a single optical sensor.

9. The display device according to claim 2,
wherein the capacitor is a P-type transistor.

10. The display device according to claim 1,
wherein each of the sensor pixel circuits further comprises a reference light-receiving element that is connected to the light-receiving element in series and that is shielded from light, and
wherein the first storage node is connected between the light-receiving element and the reference light-receiving element.

11. The display device according to claim 1,
wherein the light-receiving element is an N-type transistor.

12. The display device according to claim 1, further comprising a select switching element that is connected to the read-out switching element in series, the select switching element being provided to establish and break electrical continuity between the second storage node and an output line of the sensor pixel circuit.

13. A driving method of a display device that comprises: a display panel that includes a plurality of display pixel circuits and a plurality of sensor pixel circuits in a display region; and a driver circuit that supplies a driving signal to the sensor pixel circuits, wherein each of the sensor pixel circuits comprises: a light-receiving element; a first storage node that accumulates electrical charges corresponding to an amount of light that entered the light-receiving element; a second storage node that is provided to retain electrical charges at the first storage node; a read-out switching element that is connected to the second storage node; a first switching element that is connected between the first storage node and the second storage node, the first switching element being operated in a saturation region when electrical charges accumulated in the first storage node are transferred to the second storage node; and a second switching element that is connected to the second storage node, the second switching element being provided for resetting the first and second storage nodes,
the driving method comprising a sensing operation that is performed by the driver circuit during a unit period, the sensing operation comprising:
a reset process in which the first switching element is turned on, the second switching element is turned on, and the first and second storage nodes are reset;
an accumulation process in which the first switching element is turned off, the second switching element is turned off, and electrical charges corresponding to an amount of light received by the light-receiving element are accumulated in the first storage node;
a transfer process in which the first switching element is turned on, the second switching element is turned off, and electrical charges that were accumulated in the first storage node in the accumulation process are transferred to the second storage node; and
a read-out process in which the first switching element is turned off, the second switching element is turned off, and the read-out switching element is turned on, thereby performing a read-out operation.

14. A driving method of a display device that comprises: a display panel that includes a plurality of display pixel circuits and a plurality of sensor pixel circuits in a display region; and a driver circuit that supplies a driving signal to the sensor pixel circuits, wherein each of the sensor pixel circuits comprises: a light-receiving element;
a first storage node that accumulates electrical charges corresponding to an amount of light that entered the light-receiving element; a second storage node that is provided to retain electrical charges at the first storage node; a read-out switching element that is connected to the second storage node; a first switching element that is connected between the first storage node and the second storage node, the first switching element being operated in a saturation region when electrical charges accumulated in the first storage node are transferred to the second storage node; and a second switching element that is connected to the second storage node, the second switching element being provided for resetting the first and second storage nodes,
the driving method comprising a sensing operation that is performed by the driver circuit during a unit period, the sensing operation comprising:
a reset process in which the first switching element is turned on, the second switching element is turned on, and the first and second storage nodes are reset;
an accumulation and transfer process in which the first switching element is turned on, the second switching element is turned off, and electrical charges corresponding to an amount of light received by the light-receiving element are accumulated in the first storage node, while transferring electrical charges that were accumulated in the first storage node to the second storage node; and
a read-out process in which the first switching element is turned off, the second switching element is turned off, and the read-out switching element is turned on, thereby performing a read-out operation.
